(19) United States
(12) Patent Application Publication
(10) Pub. No.: US 2016/0253041 A1
(43) Pub. Date: Sep. 1, 2016

(54) TOUCH MODULE, ELECTRONIC DEVICE INCLUDING THE SAME, AND OPERATION METHOD THEREOF

(71) Applicant: Samsung Electronics Co., Ltd., Gyeonggi-do (KR)

(72) Inventors: Jong Dae PARK, Seoul (KR); Heon Seok LEE, Gyeonggi-do (KR); Hoon Do HEO, Gyeonggi-do (KR)

(21) Appl. No.: 15/054,946

(22) Filed: Feb. 26, 2016

(30) Foreign Application Priority Data
Feb. 27, 2015 (KR) 10-2015-0028006

(51) Int. Cl. G06F 3/041; G06F 3/044

(52) U.S. Cl. CPC G06F 3/0418; G06F 3/0412; G06F 3/044; G06F 3/0414; G06F 2203/04101; G06F 2203/04106

(57) ABSTRACT

An electronic device including a touch module is provided. The electronic device may include an external housing including a transparent plate forming a front surface of the electronic device; a display panel, at least part of which is exposed through the transparent plate; a touch panel adjacent the display panel; a memory; and a processor operably coupled to the memory. The memory may store instructions which, when executed by the processor, cause the processor to: receive first data including an input sensed by a first sensor of a first type through the touch panel, and receive second data including an input sensed by a second sensor of a second type through the touch panel. The processor may compare the first data with the second data to generate a comparison result, and determine whether an object detected using at least one of the first or second sensors is a foreign object in direct contact with the transparent plate, based on at least part of the comparison result.

### CLAIM OF PRIORITY

This application claims the benefit under 35 U.S.C. §119(a) of a Korean patent application filed on Feb. 27, 2015 in the Korean Intellectual Property Office and assigned Serial number 10-2015-0028006, the entire disclosure of which is hereby incorporated by reference.

### TECHNICAL FIELD

The present disclosure relates generally to methods and apparatuses for operating touch modules.

### BACKGROUND

Electronic devices employing touch panels as an input means are now in wide commercial use. In particular, portable devices such as smartphones and tablets with touchscreens are examples of such electronic devices. Touch panel based devices may have the capability of receiving touch inputs made via direct touch on a front surface of the device, as well as hovering inputs in which a touch implement (e.g., user's finger or a stylus) is proximate, but not touching, the front surface.

However, touch panel based devices may have a tendency to erroneously recognize touch inputs due to foreign substances falsely sensed as touches through the touch panel. While the user performs a touch input using a specific object (e.g., his or her stylus or finger, and the like) through a touch panel (e.g., of a touchscreen), foreign substances such as waterdrops, constant fluids including water, or other conductive fluids may be in contact with the touch panel. In this scenario, the electronic device may recognize the foreign substances as a touch input irrespective of the intention of the user, which may cause an erroneous operation.

### SUMMARY

Aspects of the present disclosure are to address at least the above-mentioned problems and/or disadvantages and to provide at least the advantages described below.

Accordingly, an aspect of the present disclosure is to provide a touch module for more accurately determining a touch state and/or prevent error recognition by foreign substance contact, an electronic device including the same, and an operation method thereof.

In accordance with an aspect of the present disclosure, an electronic device may include: an external housing including a transparent plate forming a front surface of the electronic device; a display panel, at least part of which is exposed through the transparent plate; a touch panel adjacent the display panel; a memory; and a processor operably coupled to the memory. The memory may store instructions which, when executed by the processor, cause the processor to: receive first data including an input sensed by a first sensor of a first type through the touch panel, and receive second data including an input sensed by a second sensor of a second type through the touch panel, and compare the first data with the second data to generate a comparison result. The processor may determine whether an object detected using at least one of the first or second sensors is a foreign object in direct contact with the transparent plate, based on at least part of the comparison result.

In various embodiments, the first sensor may be a mutual-capacitance type sensor while the second sensor may be a self-capacitance type sensor. The mutual-capacitance type sensor may be designated for detecting direct touch inputs while the self-capacitance type sensor may be designated for detecting hovering inputs. The foreign object may be a fluidic object.

In accordance with another aspect of the present disclosure, a method for operating an electronic device is provided. The method may include receiving first data including an input sensed by a first sensor of a first type through a touch panel; receiving second data including an input sensed by a second sensor of a second type through the touch panel; comparing the first data with the second data to generate a comparison result; and determining whether an object detected using at least one of the first or second sensors is a foreign object in direct contact with a front surface of the electronic device, based on at least part of the comparison result.

In accordance with another aspect of the present disclosure, a touch module is provided. The touch module may include a touch panel, a buffer, and a touch control module configured to electrically connect with the buffer and the touch panel. The buffer may store instructions set such that the touch control module receives first data including an input sensed by a first sensor of a first type through the touch panel, receives second data including an input sensed by a second sensor of a second type through the touch panel, compares the first data with the second data to generate a comparison result, and determines whether an object is in direct contact with the touch panel, whether the object is proximate the touch panel within a prescribed distance thereof or is not in contact with the touch panel, or whether fluids are in contact with the touch panel, based on at least part of the compared result.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a drawing diagram illustrating the schematic appearance of a touch module according to an embodiment of the present disclosure;

FIG. 1B is a drawing illustrating an operation method of a touch control module according to various embodiments of the present disclosure;

FIG. 2 is a block diagram illustrating a configuration of a touch control module according to various embodiments of the present disclosure;

FIG. 3 is a drawing illustrating first touch type information with a table form according to various embodiments of the present disclosure;

FIG. 4 is a drawing illustrating second touch type information according to various embodiments of the present disclosure;

FIG. 5 is a drawing illustrating information processing of a touch information processing module according to various embodiments of the present disclosure;

FIG. 6A is a block diagram illustrating an operation environment of an electronic device according to various embodiments of the present disclosure;

FIG. 6B is a drawing illustrating an analysis of a touch panel according to various embodiments of the present disclosure

FIG. 7 is a drawing illustrating a screen interface according to operation of a touch panel according to various embodiments of the present disclosure;

FIG. 8 is a drawing illustrating an operation state of an electronic device according to various embodiments of the present disclosure;

FIG. 9 is a flowchart illustrating a method for operating a touch module of an electronic device according to various embodiments of the present disclosure;

FIG. 10 is a flowchart illustrating a touch operation method of an electronic device according to various embodiments of the present disclosure;

FIG. 11 is a block diagram illustrating a configuration of an electronic device according to various embodiments of the present disclosure; and

FIG. 12 is a block diagram illustrating a configuration of a program module according to various embodiments of the present disclosure.

Throughout the drawings, it should be noted that like reference numbers are used to depict the same or similar elements, features, and structures.

### DETAILED DESCRIPTION

Hereinafter, the present disclosure is described with reference to the accompanying drawings. Various modifications are possible in various embodiments of the present disclosure and embodiments are illustrated in drawings and related detailed descriptions are listed. However, the present disclosure is not intended to be limited to the specific embodiments, and it is understood that it should include all modifications and/or, equivalents and substitutes within the scope and technical range of the present disclosure. With respect to the descriptions of the drawings, like reference numerals refer to like elements.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The expressions such as “first”, or “second”, and the like used in various embodiments of the present disclosure may refer to various elements irrespective of the order and/or priority of the corresponding elements, but do not limit the corresponding elements.

The expressions may be used to distinguish one element from another element. For instance, both “a first user device” and “a second user device” indicate different user devices from each other irrespective of the order and/or priority of the corresponding elements. For example, a first component may be referred to as a second component and vice versa without departing from the scope of the present disclosure.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

Depending on the situation, the expression “configured to” used herein may be used as, for example, the expression “suitable for”, “having the capacity to”, “designed to”, “adapted to”, “made to”, or “capable of”. The term “configured to” does not mean only “specifically designed to”. Instead, the expression “a device configured to” may mean that the device is “capable of” operating together with another device or other components. For example, a “processor configured to perform A, B, and C” may mean a generic-purpose processor (e.g., a central processing unit (CPU) or an application processor) which may perform corresponding operations by executing one or more software programs which stores a dedicated processor (e.g., an embedded processor) for performing a corresponding operation.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

Electronic devices according to various embodiments of the present disclosure may include at least one of, for example, smart phones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments of the present disclosure, the wearable devices may include at least one of accessory-type wearable devices (e.g., watches, rings, bracelets, anklets, necklaces, glasses, contact lenses, or head-mounted-devices (HMDs)), fabric or clothing integral wearable devices (e.g., electronic clothes), body-mounted wearable devices (e.g., skin pads or tattoos), or implantable wearable devices (e.g., implantable circuits).

The electronic devices may be smart home appliances. The smart home appliances may include at least one of, for example, televisions (TVs), digital versatile disk (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV′, or Google TV™), game consoles (e.g., Xbox™ and PlayStation™), electronic dictionaries, electronic keys, camcorders, or electronic picture frames.

The electronic devices may include at least one of various medical devices (e.g., various portable medical measurement devices (e.g., blood glucose meters, heart rate meters, blood pressure meters, or thermometers, and the like), a magnetic resonance angiography (MRA), a magnetic resonance imaging (MRI), a computed tomography (CT), scanners, or ultrasonic devices, and the like), navigation devices, global navigation satellite system (GNSS), event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

The electronic devices may include at least one of parts of furniture or buildings/structures, electronic boards, electronic signature receiving devices, projectors, or various measuring instruments (e.g., water meters, electricity meters, gas meters, or wave meters, and the like). The electronic devices according to various embodiments of the present disclosure may be one or more combinations of the above-mentioned devices. The electronic devices according to various embodiments of the present disclosure may be flexible electronic devices. Also, electronic devices according to various embodiments of the present disclosure are not limited to the above-mentioned devices, and may include new electronic devices according to technology development

Hereinafter, electronic devices according to various embodiments of the present disclosure will be described with reference to the accompanying drawings. The term “user” used herein may refer to a person who uses an electronic device or may refer to a device (e.g., an artificial electronic device) that uses an electronic device.

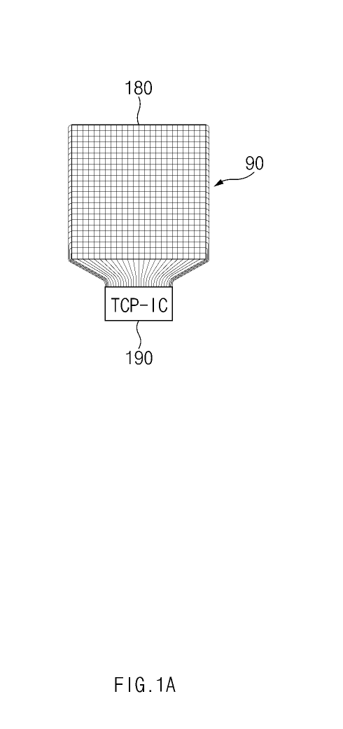

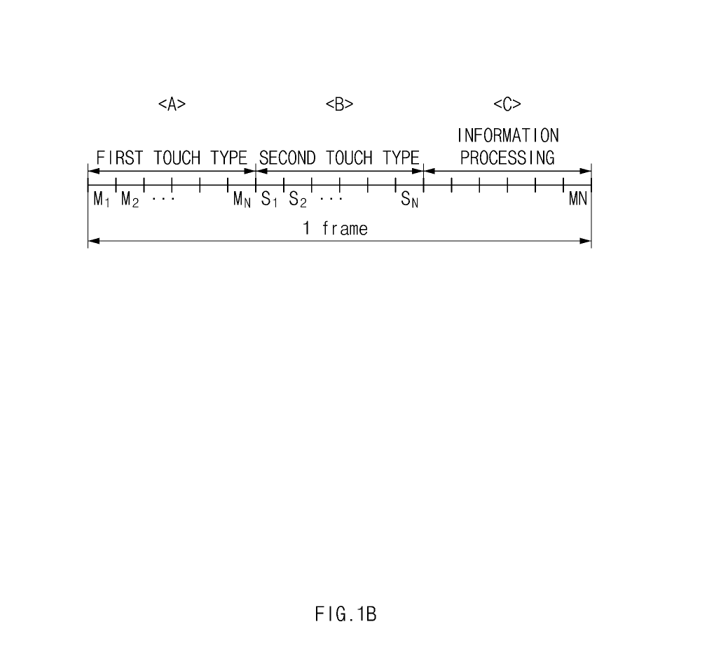

FIG. 1A is a drawing schematically illustrating a touch module 90 according to an embodiment of the present disclosure. Touch module 90 may include a touch panel 180 and a touch control module 190.

The touch panel 180 may include a touch sensor comprising touch cells (or may functionally connect with the touch sensor). Touch panel 180 may detect an external object, i.e., a touch implement such as a stylus or a user's finger which may be sensed by the touch sensor when in contact with or proximate a front surface of at least part of the touch panel 180. It is noted here that the term “touch” used herein may refer to direct touch contact or to a “proximity touch” which occurs when a touch implement is in proximity to the touch panel 180. The touch panel 180 may use various technologies which may detect an external object and may include, for example, a resistive type, a capacitive type, an infrared type, an acoustic type, an optical type, a carbon nano tube (CNT) type, or an electromagnetic induction type of sensor. Also, an image sensor, a proximity sensor, or a conductive pattern installed to be adjacent to a housing of an electronic device may be used to sense a touch on the electronic device. The discussion below will refer to capacitive sensing as an example of a type of sensing performed by the touch panel, but it is understood that other types of sensing, such as the alternatives just mentioned, may be employed.

Capacitive type sensing detects an input position using a change of capacitance which occurs as a touch implement, e.g., an input tool or a human body appendage, is in contact with or proximal a sensing electrode which is formed of a conductive material, for example, an indium thin oxide (ITO) or a metal mesh. A mutual capacitance type of sensing may be, for example, a type using capacitance between two sets of electrodes that may be arranged orthogonally to each other. One set of electrodes may be arranged horizontally while the other set of electrodes may be arranged on vertically to form sensors of a lattice structure. Sensing circuitry may be coupled to the electrodes such that a change of capacitance in each of a plurality of nodes of the lattice structure at intersecting points of the electrodes may be detected by measuring capacitance generated between the orthogonal electrodes. In this manner, mutual capacitance type sensing is particularly useful for accurate sensing of multiple simultaneous touches, often referred to as multi-touches.

A self-capacitance type of sensor may similarly include a first set of electrodes arranged horizontally and a second set of electrodes arranged vertically, but the two sets of electrodes may form sensors independent of each other. A change of capacitance at each horizontal and vertical “channel” may be detected by measuring capacitance generated by each electrode. Thereby, the self-capacitance sensing circuitry may be less complex than that of the mutual capacitance sensing circuitry. The touch module 90 may detect, for example, contact or proximity of an external object to at least part of an electronic device using the mutual capacitance type or the self capacitance type. According to various embodiments of the present disclosure, the touch module 90 may detect contact by the external object using mutual capacitance and may detect proximity (e.g., a hovering state) of the external object using self-capacitance. Note that a hovering input is not typically used for simultaneous touches, whereby a self-capacitance type sensor may be sufficient for the hovering input.

In the following example, for convenience of description, the mutual-capacitance type sensor will be referred to as a first type of sensor/sensing, or just first sensing/first sensor while the self-capacitance type of sensor will be referred to as a second type of sensor/sensing, or just second sensor/second sensing. Since the mutual-capacitance type sensor may also be designated for sensing direct touch inputs while the self-capacitance sensor may be designated for sensing hovering inputs, the mutual-capacitance type sensor may also be said to collect “first touch type” information while the self-capacitance type sensor may be said to collect “second touch type” information.

The touch panel 180 may include a touch region, a trace region and a transparent layer through which part of a display panel (also referred to as a display) is exposed so that images from the display are output. The transparent layer may define an outer surface of the touch panel upon which touch contact with a touch implement is made. The transparent layer or the touch panel itself may be referred to as a transparent plate through which the display images are output, and may be considered to form part of a housing of the electronic device. The electronic device may include an external protection layer. The external protection layer may be formed as a glass layer at the outer surface of the touch panel or the display panel. The external protection layer may be the transparent layer or the transparent plate. The touch region may include, for example, a region where a touch cell array of a first sensor type (e.g., a mutual capacitance type of sensor) and a touch cell array of a second touch type (e.g., a self-capacitance type of sensor) are integrated. Hereafter, for convenience of description of certain examples, the term “first sensor” may be used to refer to a sensing circuit comprising detection/processing circuitry along with multiple first electrodes sufficient for mutual-capacitance type sensing of touches. The term “second sensor” may be used to refer to a sensing circuit comprising detection/processing circuitry in conjunction with multiple second electrodes sufficient for self-capacitance type sensing of touches. The first and second sensors may share all or a part of the multiple electrodes. The touch region may include a first sensor region including a plurality of transmit electrodes for receiving a touch signal according to the first sensor and a plurality of receive electrodes disposed to intersect the transmit electrodes. Alternatively, the touch region may include a second sensor region including communicating signal lines for communicating a signal according to the second sensor and sensing electrodes which are connected to the communicating signal lines and are disposed in a matrix form.

The first sensor region and the second sensor region may be divided and disposed on a plurality of layers. Alternatively, the second sensor region may be disposed between the first sensor region on the same layer. The second sensor region may include, for example, sensing electrodes disposed as a predetermined pattern shape (e.g., a diamond shape and the like). The trace region may be a region where trace lines, which connect receive electrodes (or transmit electrodes) included in the first sensor region to the touch control module 190, are disposed. Alternatively, the trace region may be a region where trace lines, which connect the communicating signal lines disposed in the second sensor region with the touch control module 190, are disposed. The touch panel 180 may be formed with, for example, various forms such as a film type, a glass type, a deposition type, and the like. The touch panel 180 may be disposed as a layer abutting, adjacent to, on or under a display panel of a display. (In a configuration where the touch panel is “on” the display panel, it may be disposed in a layer closer to a front surface of the electronic device. If the touch panel is “under” the display panel it may be disposed behind the display panel, i.e., in a layer further from the electronic device front surface than the display panel.)

The touch control module 190 may provide a signal to the touch panel 180 using power supplied thereto, may analyze a detected signal, and may generate touch coordinate information. In this regard, the touch control module 190 may be disposed to independently operate a first sensor region and the second sensor region, which are disposed on the touch panel 180. For example, the touch control module 190 may operate signal lines for operating the first sensor region and signal lines for operating the second sensor region to be independent of each other. The touch control module 190 may alternately operate the first sensor the second sensor according to predetermined scheduling. The touch control module 190 may determine at least one of an approach state (e.g., a contact state or a hovering state) of a touch object or a contact state of foreign substances according to first sensor information (which may also be referred to as first data) or second sensor information (or second data), which are obtained according to alternate operation. The touch control module 190 may cancel a contact region of foreign substances.

FIG. 1B is a drawing illustrating an operation method of a touch control module according to various embodiments of the present disclosure. In this method, a touch control module 190 of FIG. 1A may collect first sensing information using the first sensor and may collect second sensing information using the second sensor during a predetermined time. In the following discussion, the first sensing information will be referred to as “first touch type” information and the second sensing information will be referred to as “second touch type” information.

Touch control module 190 may perform sensing according to the first touch type, within a period of one frame according to a frequency set to display an image on a display of an electronic device, during an A time, may perform sensing according to the second touch type during a B time, and may then process information (e.g., may calculate a touch coordinate) during a C time. In this operation, the touch control module 190 may control the touch panel 180 to perform sensing according to the first touch type a first predetermined number of times (M1, M2, . . . , MN, where N is a natural number) and to perform sensing according to the second touch type a second predetermined number of times (S1, S2, . . . , SK, where K is a natural number). The first predetermined number of times may be the same as the second predetermined number of times. The first predetermined number of times and the second predetermined number of times may be changed according to, for example, a length of one frame applied to the display of the electronic device. For example, if a touch sampling frequency, i.e., a frequency at which the frame of FIG. 1B recurs, is applied to the display is relatively high, the first predetermined number of times and the second predetermined number of times may be relatively small. The touch control module 190 may adjust the first predetermined number of times and the second predetermined number of times may in response to amplitude of the touch sampling frequency applied to the display.

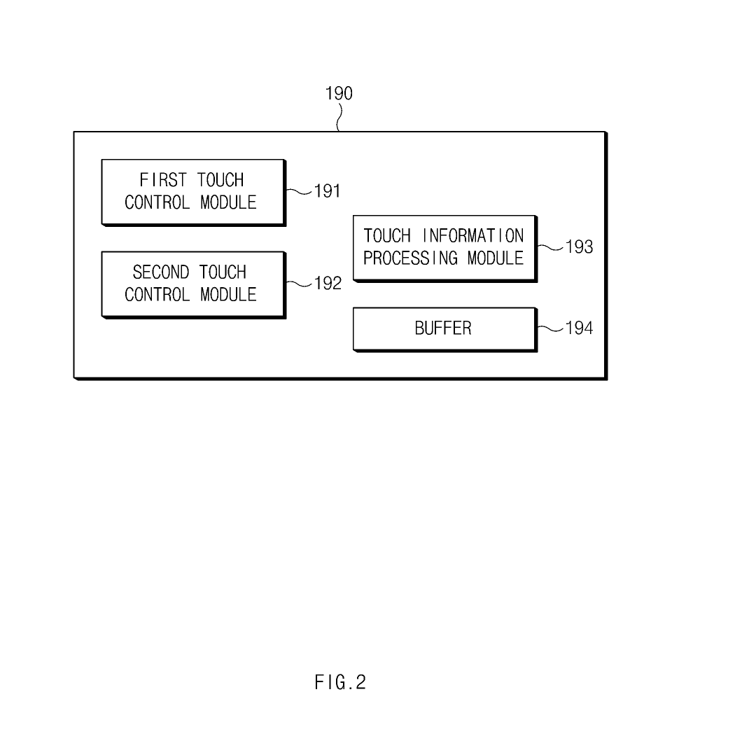

FIG. 2 is a block diagram illustrating a configuration of a touch control module, 190, according to various embodiments of the present disclosure. Touch control module 190 may include a first touch control module 191, a second control module 192, a touch information processing module 193, and a buffer 194.

The first touch control module 191 may control, for example, sensing according to a first touch type. In this regard, the first touch control module 191 may include a signal providing unit which may provide a predetermined touch signal to transmit electrodes disposed on a first touch type region and a signal collecting unit which may connect to receive electrodes and may collect a sensing signal. The first touch control module 191 may sequentially or simultaneously provide a predetermined touch signal to the transmit electrodes during a predetermined scheduled time (e.g., part of a time when one frame is displayed). Alternatively, the first touch control module 191 may divide the transmit electrodes into at least one group during a predetermined time and may simultaneously or sequentially provide a predetermined touch signal to the transmit electrodes per at least one group. The first touch control module 191 may sequentially or simultaneously scan receive electrodes in response to providing the touch signal to the transmit electrodes and may collect first touch type information. Alternatively, the first touch control module 191 may divide the receive electrodes into at least one group, may scan the receive electrodes per at least one group, and may collect the first touch type information. The first touch control module 191 may send the collected first touch type information to the touch information processing module 193. Also, the first touch control module 191 may send notification that sensing according to the first touch type is completed to the second touch control module 192.

The second touch control module 192 may control, for example, sensing according to a second touch type. In this regard, the second touch control module 192 may include a signal communicating unit which provides a transmit signal to touch cells disposed on a second touch type region and senses a change of the provided signal. The second touch control module 192 may communicate a signal with touch cells during a predetermined scheduled time (e.g., part of a time when one frame is displayed) and may collect second touch type information. The second touch control module 192 may send the collected second touch type information to the touch information processing module 193. Also, if sensing according to the second touch type in the second touch control module 192 is performed to be faster than sensing according to the first touch type, the second touch control module 192 may send notification that the sensing according to the second touch type is completed to the first touch control module 191.

The touch information processing module 193 may collect the first touch type information from the first touch control module 191 and may collect the second touch type information from the second touch control module 192. The touch information processing module 193 may analyze the collected first touch type information and the collected second touch type information and may determine at least one of an approach state of a touch object or whether foreign substances are in contact with a touch panel 180 of FIG. 1A. If it is determined that a touch object is in a contact state according to the first touch type information (e.g., mutual capacitance type information), the touch information processing module 193 may calculate a touch coordinate on a contact node of the touch object and may process a touch input according to the calculated touch coordinate. Also, if the touch object is in a proximity state according to the second touch type information (e.g., self capacitance type information), the touch information processing module 193 may process an input according to a hovering state. Also, if it is determined that foreign substances are in contact with the touch panel 180, the touch information processing module 193 may cancel a touch input by the foreign substances.

The touch information processing module 193 may detect information about nodes (or points, regions, and channels) of first touch type information which has a predetermined first reference value or more among the collected first touch type information. Also, the touch information processing module 193 may detect information about nodes of second touch type information which has a predetermined second reference value or more among the collected second touch type information. The first reference value and the second reference value may be same as or different from each other. The touch information processing module 193 may detect whether there are nodes in which nodes where the collected first touch type information has the first reference value or more and nodes where the collected second touch type information has the second reference value or more are overlapped. If detecting the overlapped nodes, the touch information processing module 193 may determine the corresponding nodes as valid touch nodes. The touch information processing module 193 may detect touch nodes where the second touch type information has less than the second reference value among the nodes where the collected first touch type information has the first reference value or more. If detecting the nodes, the touch information processing module 193 may determine the corresponding nodes as invalid touch nodes.

The touch information processing module 193 may operate a normal touch sensing value distribution table in a normal state or a set state. The touch information processing module 193 may initialize the touch panel 180 in a process of turning on the touch panel 180 after the touch panel 180 is turned off. In this operation, the touch information processing module 193 may determine whether foreign substances are currently in contact with the touch panel 180 with reference to a normal touch sensing value distribution table stored in the buffer 194.

Touch information processing module 193 may determine a performing order and period of the first touch control module 191 and a performing order and period of the second touch control module 192 in response to setting information. For example, the touch information processing module 193 may be scheduled such that the first touch control module 191 (or the second touch control module 192) collects first touch type information a predetermined number of times (or during a predetermined time) according to the setting information. Thereafter, the touch information processing module 193 may be scheduled such that the second touch control module 192 (or the first touch control module 191) collects second touch type information a predetermined number of times (or during a predetermined time) according to the setting information. The touch information processing module 193 may send scheduling information to the first touch control module 191 or the second touch control module 192 at a corresponding time. If scheduling information is not sent, a touch module 90 of FIG. 1A may send notification that the first touch control module 191 (or the second touch control module 192) completes sensing to the second touch control module 192 (or the first touch control module 191) to collect another touch type information.

The buffer 194 may include at least one of a register, a memory, or a storage, which is electrically connected to the touch information processing module 193. Therefore, the buffer 194 for storing information necessary for operating the touch module 90 may be, for example, a memory for the touch module 90. Buffer 194 may be provided in the form of being mounted on the touch control module 190. Alternatively, the buffer 194 may be disposed outside the touch control module 190 and may connect with the touch control module 190. Buffer 194 may store a normal touch sensing value table. The normal touch sensing value table may include a touch panel sensing value table generated according to the first touch type information and the second touch type information, which are detected in a state where foreign substance are not in contact with the touch panel 180. The normal touch sensing value table may be used as a reference value in a process of initializing the touch panel 180. The normal touch sensing value table may be updated by information received from the outside. Buffer 194 may temporarily store sensing information according to the first touch type or sensing information according to the second touch type. Also, the buffer 194 may temporarily store a touch coordinate value generated according to the first touch type sensing information and the second touch type sensing information. The touch coordinate value stored in the buffer 194 may be sent to, for example, a processor of an electronic device electrically connected with the touch module 90.

Buffer 194 may store instructions set collect the first touch type information (or first data), to collect the second touch type information (or second data), and to detect a region where a region of data which have a reference value or more among the first data and a region of data which have a reference value or more among the second data are overlapped. Alternatively, the buffer 194 may store instructions set to receive the first data including an input sensed by the first touch type (or the first type) (e.g., the mutual capacitance type) through the touch panel 180, to receive the second data including an input sensed by the second touch type (or the second type) (e.g., the self-capacitance type) different from the first type through the touch panel 180, to compare the first data with the second data, and to determine whether an object is in direct contact with the touch panel 180, whether the object is close within a selected distance or is not in contact with the touch panel 180 (or is in a non-contact state), or whether fluids are in contact with the touch panel 180, based on at least part of the compared result.

In FIG. 2, an embodiment of the present disclosure is exemplified as the sensing according to the second touch type is performed under control of the second touch control module 192 after the sensing according to the first touch type is performed under control of the first touch control module 192. However, other timing sequences are available. For instance, the touch control module 190 may first perform the sensing according to the second touch type and may then perform the sensing according to the first touch type. According to another embodiment, the touch control module 190 may perform the sensing according to the first touch type or the sensing according to the second touch type irrespective of an order. Also, the sensing according to the first touch type under the control of the first touch control module 191 and the sensing according to the second touch type under the control of the second touch control module 192 may be simultaneously performed. The touch control module 190 may collect sensing information according to the sensing according to the first touch type or the sensing according to the second touch type, and may perform processing according to an approach state of a touch object or may cancel a touch input by foreign substances.

An embodiment of the present disclosure is exemplified as the touch control module 190 includes the first touch control module 191 for collecting the first touch type information, the second touch control module 192 for collecting the second touch type information, and the touch information processing module 193 for processing the collected information. In an alternative arrangement, the first touch control module 191, the second touch control module 192, and the touch information processing module 193 may be integrated into one component, for example, the touch control module 190. In this case, the touch control module 190 may collect first touch type information during a constant period according to scheduled information, may collect second touch type information during another constant period, and may perform processing according to an approach state of a touch object or may cancel a touch input by foreign substances.

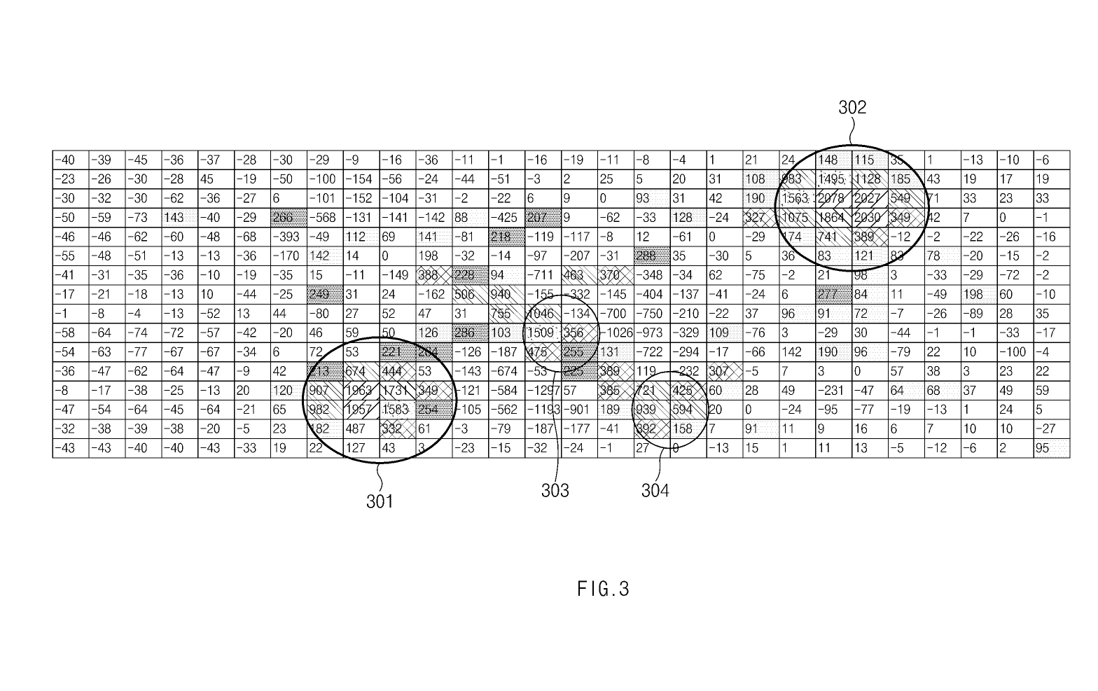

FIG. 3 depicts a table representing a distribution of first sensor type information according to various embodiments of the present disclosure. As discussed earlier, first sensor type information may be information sensed by a mutual capacitance type. As shown in FIG. 3, the first sensor type information may include sensing values on a region of a touch panel 180 of FIG. 1A. A region where a touch input (e.g., a touch contact or hovering) is generated by a user's touch implement and a region which is in contact with foreign substances may be included in the touch panel 180. In this case, in the first sensor type information, a first point 301 and a second point 302 generated by touch of a user's fingers, and third and fourth points 303, 304 generated by contact by foreign substances may each have a distribution of sensing values which differ, by more than a threshold amount, from those of ambient regions. (In this context, “point” may refer to a small area or region of touch contact.) Therefore, if touch recognition is performed according to the first sensor type information, a touch control module 190 of FIG. 2 may preliminarily determine, based on predefined criteria, that touches are generated on each of the points 301, 302, 303 and 304, even though the touch contact recognition at points 303 and 304 is due to foreign substances. However, using the technique described below, such touch contact may be identified as contact caused by foreign substances, whereby such touch contact may be ignored so that erroneous responses may be prevented.

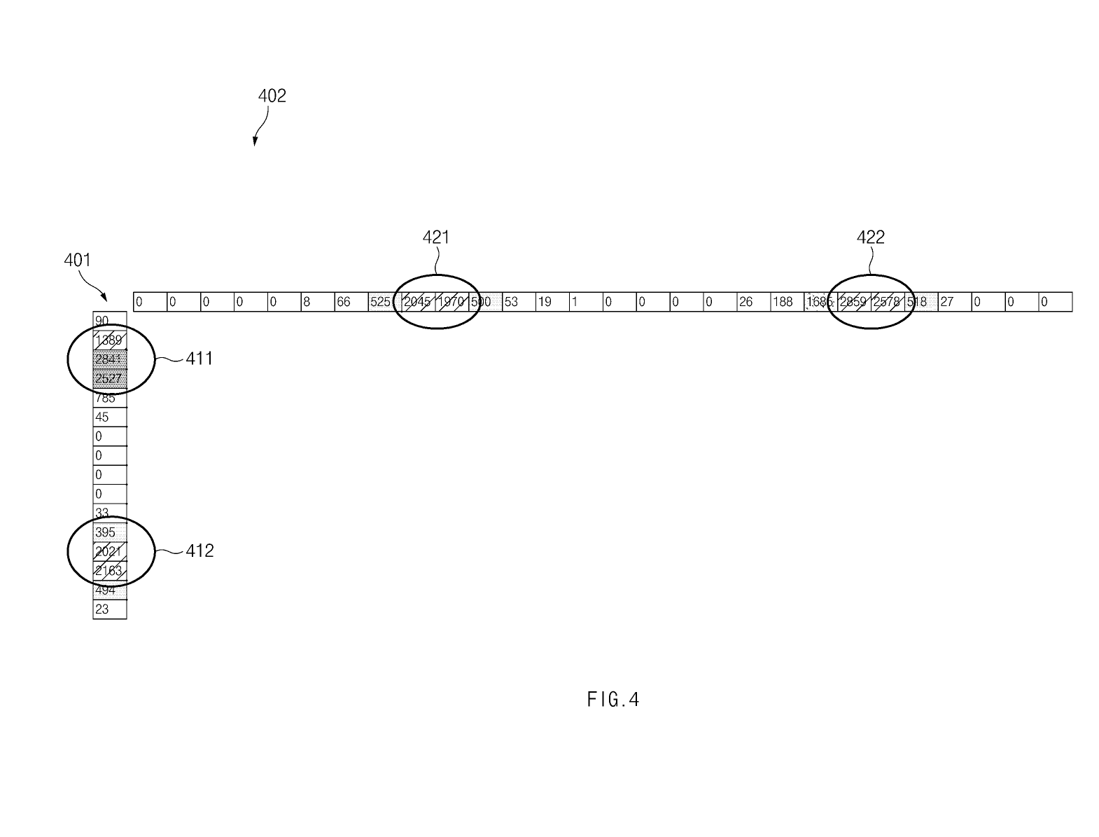

FIG. 4 is a drawing illustrating second sensor type information according to various embodiments of the present disclosure. As discussed earlier, the second sensor information may be information sensed by a self-capacitance type circuit. According to the self-capacitance sensing, the second sensor information may include X-axis information 401 and Y-axis information 402. As described with reference to FIG. 3, in a state where real touches are generated on a first point 301 and a second point 302 on a touch panel 180 of FIG. 1A and where foreign substances are in contact with a third point 303 and a fourth point 304, a first detection point 411 and a second detection point 412 in the X-axis information 401 may have sensing values different from, i.e., outside a range expected from, those of ambient regions. Also, a third detection point 421 and a fourth detection point 422 in the Y-axis information 402 may have sensing values different from those of ambient regions. In case of the self-capacitance sensing, foreign substances such as typical water droplets which are in contact with the touch panel 180 generally do not produce a large capacitance change above a threshold normally expected for a proximity touch or a direct touch with a touch implement. Since a typical foreign substance may span an area smaller than a finger or stylus touched region, and produces only a small capacitance change consistent with an object floating on the touch panel surface without a separate ground connection, a self-capacitance type sensor may not detect its presence. Therefore, if the touch panel 180 is scanned with the self-capacitance type sensor, the floating foreign substances may be detected as having approximately the same sensing value as an ambient region. Therefore, information about a point which is in contact with foreign substances may not be detected as a real user touch among the second sensor type information.

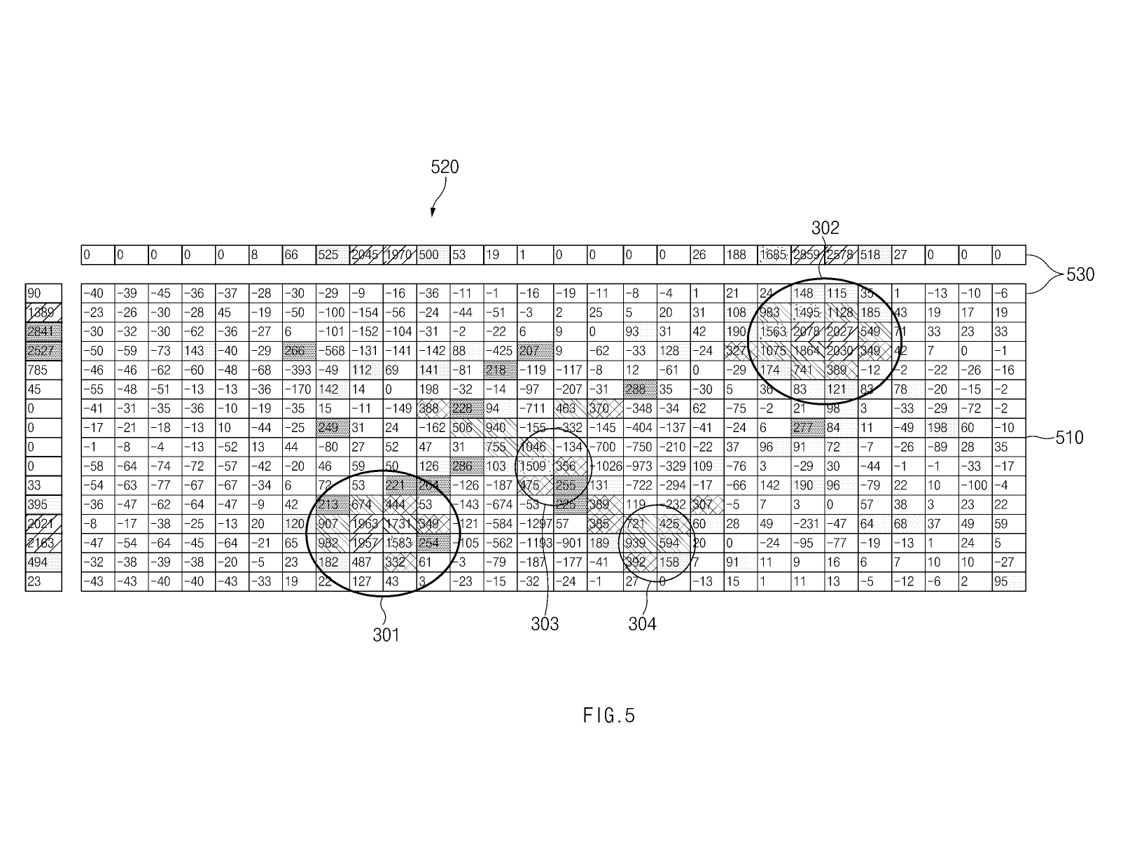

FIG. 5 is a drawing illustrating information processing of a touch information processing module according to various embodiments of the present disclosure. The example of FIG. 5 combines the sensing information collected by the different sensor types of FIGS. 3 and 4. From the information of FIG. 5, a touch information processing module 193 of FIG. 2 may receive first touch type information 510 from a first touch control module 191 of FIG. 2, may receive second touch type information 520 from a second touch control module 192 of FIG. 2, and may generate a composite information table 530. The touch information processing module 193 may determine information of a first point 301 and a second point 302, in which information about detected points among the first touch type information 510 and information about detected points among the second touch type information 520 in the composite information table 530 are overlapped, as valid information. If detecting the information of the first point 301 and the second point 302 as the valid information, the touch information processing module 193 may calculate a coordinate value for the corresponding information. In this operation, the touch information processing module 193 may calculate coordinate information of the first point 301 and the second point 302 in the first touch type information 510.

As described above, according to various embodiments of the present disclosure, a touch module may include a touch panel, a buffer, and a touch control module configured to electrically connect with the buffer and the touch panel. The buffer may store instructions set such that the touch control module receives first data including an input sensed by a first type through the touch panel, receives second data including an input sensed by a second type different from the first type through the touch panel, compares the first data with the second data, and determines whether an object is in direct contact with the touch panel, whether the object is close within a selected distance or is not in contact with the touch panel, or whether fluids are in contact with the touch panel, based on at least part of the compared result.

As described above, according to various embodiments of the present disclosure, a touch module may include a touch panel and a touch control module. The touch control module may include a first touch control module configured to collect first touch type information, a second touch control module configured to collect second touch type information, and a touch information processing module configured to detect nodes, overlapped and detected according to the collected first touch type information and the collected second touch type information, as a valid touch region.

According to various embodiments of the present disclosure, the touch module may further include a buffer configured to store instructions set to collect the first touch type information, to collect the second touch type information, and to detect nodes, in which nodes where the first touch type information has a reference value or more and nodes where the second touch type information has the reference value or more are overlapped, as valid touch nodes.

According to various embodiments of the present disclosure, the touch control module may process detected nodes, which have a sensing value where the second touch type information has less than a second reference value, among nodes where the first touch type information has a first reference value or more as invalid touch nodes.

According to various embodiments of the present disclosure, the touch control module may perform sensing according to a first touch type a first predetermined number of times during a constant period and may perform sensing according to a second touch type a second predetermined number of times during a constant period. The first predetermined number of times and the second predetermined number of times may be the same as each other.

According to various embodiments of the present disclosure, the touch control module may calculate a touch point according to touch type information collected after performing sensing according to a first touch type and sensing according to a second touch type in an actually identical type within a period when one frame is displayed.

According to various embodiments of the present disclosure, the touch control module may alternately perform sensing according to a first touch type and sensing according to a second touch type during a constant period.

According to various embodiments of the present disclosure, the touch control module may alternately perform sensing according to a first touch type and sensing according to a second touch type and may calculate a touch point during a period when one frame is displayed.

According to various embodiments of the present disclosure, the touch module may further include a buffer configured to store a normal touch sensing value distribution table generated according to first touch type information and second touch type information in a state where foreign substances are not in contact with a touch panel included in the touch module.

According to various embodiments of the present disclosure, the touch control module may verify whether foreign substances are in contact with the touch panel according to the normal touch sensing value distribution table in an initialization process.

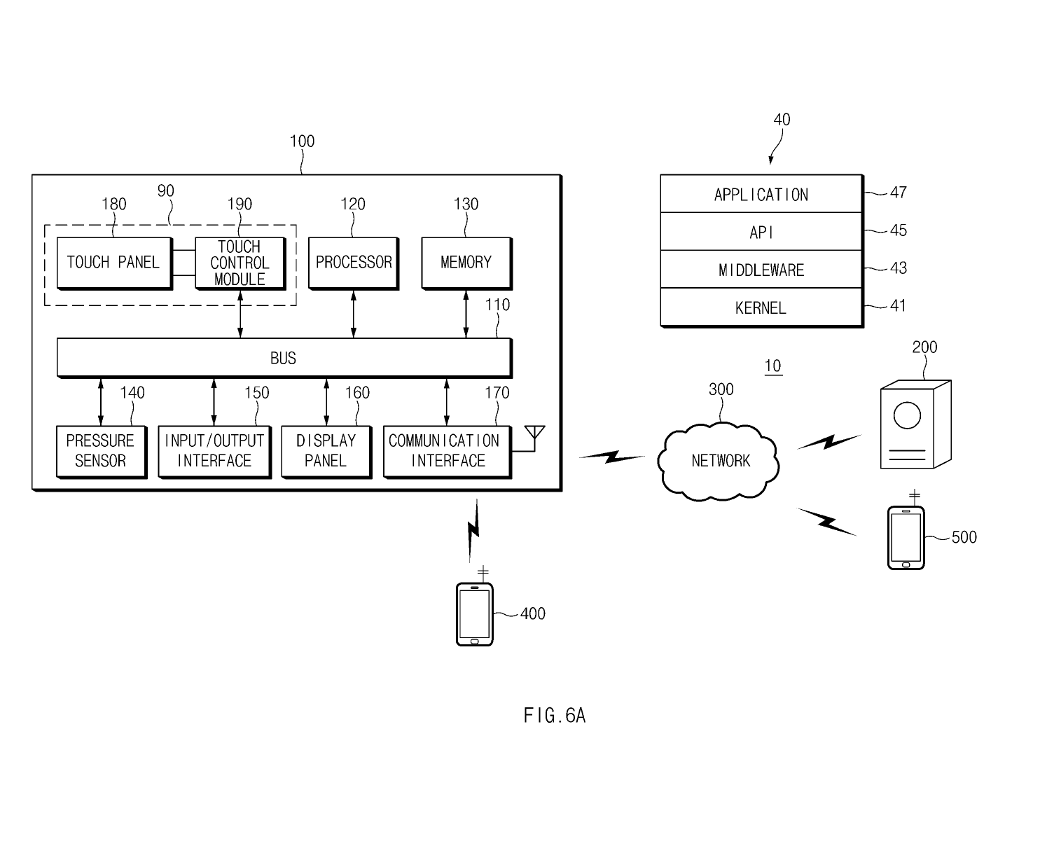

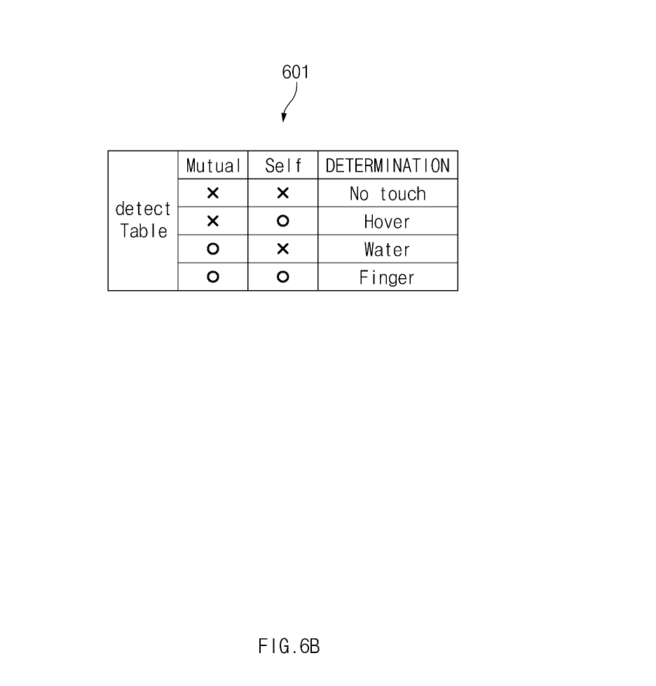

FIG. 6A is a block diagram illustrating an operation environment of an electronic device according to various embodiments of the present disclosure. An operation environment 10 may include an electronic device 100, a network 300, and a server device 200.

Electronic device 100 may include a touch module 90 that may collect first touch type information and second touch type information and may cancel a touch input by foreign substances which are in contact with a touch panel 180. In this operation, information about settings of a first touch type and a second touch type of the electronic device 100 may be provided from first and second external electronic devices 400 and 500 or a server device 200. According to an embodiment of the present disclosure, the server device 200 (or the first and second external electronic devices 400 and 500) may provide a normal touch sensing value table necessary for operating the touch module 90.

The network 300 may establish a communication channel between the electronic device 100 and the second external electronic device 500 or the server device 200. The network 300 may establish, for example, a communication channel between the electronic device 100 and the server device 200 and may send a setting information request message or a table request message of the electronic device 100 to the server device 200. Also, the network 300 may send setting information and table information, provided from the server device 200, to the electronic device 100. The setting information may include, for example, setting information associated with operating the first touch type and the second touch type of the electronic device 100. If a frame frequency of a display panel 160 is changed, a period when the first touch type is applied and a period when the second touch type is applied may be changed. Therefore, the setting information may include information about a period when the first touch type is applied or the number of times the first touch type is applied, which corresponds to the frame frequency of the display panel 160, and information about a period when the second touch type is applied or the number of times the second touch type is applied, which corresponds to the frame frequency of the display panel 160. The table information may include, for example, a normal touch sensing value table.

The server device 200 may connect with the electronic device 100 over the network 300. The server device 200 may provide setting information or table information to the electronic device 100 in response to a request of the electronic device 100. For example, the electronic device 100 may receive frame frequency information of the display panel 160 of the electronic device 100 from the server device 200. The server device 200 may provide the setting information of the first touch type and the second touch type corresponding to a frame frequency to the electronic device 100. Also, the server device 200 may receive a table request message from the electronic device 100. The server device 200 may provide table information to the electronic device 100 in response to a request of the electronic device 100. In this operation, the server device 200 may receive information about the touch module 90 (e.g., information about a size, resolution, and an operation method of the touch panel 180) from the electronic device 100 and may provide table information corresponding to the corresponding touch module 90.

Each of the first and second external electronic devices 400 and 500 may be the same as, or a different device than, electronic device 100. According to an embodiment of the present disclosure, the server device 200 may include a group of one or more servers. According to various embodiments of the present disclosure, all or some of operations executed in the electronic device 100 may be executed in another electronic device or a plurality of electronic devices (e.g., the first and second external electronic devices 400 and 500 or the server device 200). According to an embodiment of the present disclosure, if the electronic device 100 should perform any function or service automatically or according to a request, it may request another device (e.g., the first and second external electronic devices 400 and 500 or the server 200) to perform at least part of the function or service, rather than executing the function or service for itself or in addition to the function or service. The other electronic device (e.g., the first and second external electronic devices 400 and 500 or the server device 200) may execute the requested function or the added function and may transmit the executed result to the electronic device 100. The electronic device 100 may process the received result without change or additionally and may provide the requested function or service. For this purpose, for example, cloud computing technologies, distributed computing technologies, or client-server computing technologies may be used.

The electronic device 100 may include the touch module 90 and may support a touch operation in response to control of the processor 120. This electronic device 100 may include an external housing configured to include a transparent plate, a display panel, at least part of which is exposed through the transparent plate, a touch panel configured to be disposed in the external housing, a memory, and a processor configured to electrically connect to the memory. The memory may store instructions set, when executed by the processor, such that the processor receives first data including an input sensed by a first type through the touch panel, receives second data including an input sensed by a second type different from the first type through the touch panel, compares the first data with the second data, and determines whether an object is in direct contact with at least part of the display panel, whether the object is close within a selected distance or is not in contact with at least part of the display panel, or whether fluids are in contact with at least part of the display panel, based on at least part of the compared result.

As described above, the touch panel may include first conductive lines extended in a first direction and second conductive lines which are extended in a second direction orthogonal to the first direction and intersect the first conductive lines. In the first type, the touch panel may sequentially or simultaneously provide a signal to the first conductive lines and may sense a change of the signal in the second conductive lines. In the second type, the touch panel may sequentially or simultaneously provide a signal to each of the first conductive lines and the second conductive lines and may sense a change of the provided signal. The instructions may be set such that the processor determines that an object is in direct contact with at least part of the touch panel, if an input sensed by the first type through the at least part of the touch panel has a first reference value or more and an input sensed by the second type through the at least part of the touch panel has a second reference value or more.

According to various embodiments of the present disclosure, the electronic device 100 may include a bus 110, the processor 120, a memory 130, a pressure sensor 140, an input and output interface 150, a display panel 160, a communication interface 170, and the touch module 90.

The bus 110 may be, for example, a circuit which connects the components 120 to 190 with each other and transmits communication (e.g., a control message and/or data) between the components. The bus 110 may send, for example, a control signal of the processor 120 to the touch module 90. Also, the bus 110 may send touch coordinate information to the processor 120.

The processor 120 may include one or more of a central processing unit (CPU), an application processor (AP), or a communication processor (CP). The processor 120 may perform, for example, calculation or data processing about control and/or communication of at least another of the components of the electronic device 100.

The processor 120 may operate a touch coordinate in a different way according to a supporting method of the touch module 90. According to an embodiment of the present disclosure, as described with reference to FIGS. 1A to 5, if the touch module 90 is designed to provide a real touch coordinate except for a foreign substance contact region, the processor 120 may process a function according to a touch coordinate received therein. For example, the processor 120 may perform processing, for example, may execute an icon mapped to the received touch coordinate or may receive information assigned to a virtual input key. The processor 120 may update setting information and table information associated with operating the touch module 90. For example, the processor 120 may verify frame frequency information of the display panel 160. The touch module 90 may verify frame frequency information. If one frame frequency information is different from another frame frequency information, the processor 120 may collect setting information corresponding to the frame frequency information of the display panel 160 and may provide the collected setting information to the touch module 90. The setting information may be, for example, information which is stored in the memory 130 or is received from the server device 200. Also, the processor 120 may determine whether a normal state sensing value table is stored in the touch module 90. If the normal state sensing value table is not stored in the touch module 90, the processor 120 may provide a table stored in the memory 130 or a table provided from the server device 200 to the touch module 90.

According to various embodiments of the present disclosure, the touch module 90 may directly send first touch type information according to first touch type sensing and second touch type information according to second touch type sensing to the processor 120. In this case, the processor 120 may generate a mixing information table by mixing the received first touch type information with the received second touch type information. The processor 120 may detect first touch type information of a first reference value or more and second touch type information of a second reference value or more and may process a touch as a valid touch. According to an embodiment of the present disclosure, the processor 120 may detect a touch (contact) point according to the first touch type information of the first reference value or more from the mixing information table and may process a touch function corresponding to the detected touch (contact) point. Also, the processor 120 may detect a hovering point according to the second touch type information of the second reference value or more from the mixing information table and may process a hovering function corresponding to the detected hovering point. Alternatively, the processor 120 may detect the first touch type information of the first reference value or more and the second touch type information of less than the second reference value and may process a touch as an invalid touch.

According to various embodiments of the present disclosure, the processor 120 may activate the pressure sensor 140 in response to at least one of a contact state of foreign substances or a touch change in the contact state of the foreign substances. The processor 120 may process a touch as a valid touch using at least one of pressure information collected through the pressure sensor 140 or touch information collected by the touch module 90.

According to various embodiments of the present disclosure, if nodes of the first touch type information of the first reference value or more and nodes of the second touch type information of less than the second reference value (e.g., a region according to distribution of nodes) are a predetermined number of nodes (e.g., a predetermined size or more) in information processing using the mixing information table, the processor 120 may activate the pressure sensor 140. The processor 120 may determine a valid touch node according to pressure information collected through the activated pressure sensor 140. Alternatively, the processor 120 may determine whether constant nodes (e.g., a region where a number of constant nodes are concentrated) of the first touch type information of the first reference value or more and the second touch type information of less than the second value are a predetermined number or more of nodes in the information processing using the mixing information table. If the constant nodes are the predetermined number or more of nodes, the processor 120 may activate the pressure sensor 140.

According to various embodiments of the present disclosure, if second touch type information among the first touch type information of the first reference value or more has less than the second reference value and then has the second reference value or more within a predetermined time, the processor 120 may activate the pressure sensor 140. In this operation, the processor 120 may control activation of the pressure sensor 140 in a different way according to a region size of the second touch type information of less than the second reference value. For example, although a touch change of the second reference value occurs, if a region of the second touch type information of the second reference value or more has less than a predetermined size, the processor 120 may not activate the pressure sensor 140. Alternatively, although a touch change of the second reference value occurs, if second touch type information which has the second reference value or more or a constant region size is less than a constant number of information, the processor 120 may not activate the pressure sensor 140. In this case, the processor 120 may process complex points, where the first touch type information of the first reference value or more and the second touch type information of the second reference value or more are overlapped, as valid points.

According to various embodiments of the present disclosure, the processor 120 may accumulate collected touch type information and may calculate a foreign substance contact region. For example, if a change of touch capacitance at a node of touch type information having a sensing value of a constant level or more among the collected touch type information is fixed during a predetermined time (or within a predetermined range), the processor 120 may detect the corresponding node as a foreign substance contact region. If touch capacitance of the foreign substance contact region is changed to a predetermined level or more (e.g., the second reference value or more), the processor 120 may perform touch processing according to the foreign substance contact region. For example, the processor 120 may output a predetermined alarm (e.g., information for guiding the foreign substance contact region) while performing touch invalidity processing. Alternatively, the processor 120 may process a start point, where a touch capacitance change occurs, as a valid touch point.

The memory 130 may store, for example, setting information or table information associated with controlling the touch module 90. The information stored in the memory 130 may be information received from the first and second external electronic devices 400 and 500 or the server device 200. The memory 130 may include a volatile and/or non-volatile memory. The memory 130 may store, for example, instructions or data associated with at least another of the components of the electronic device 100. According to an embodiment of the present disclosure, the memory 130 may software and/or a program 40. The program 40 may include, for example, a kernel 41, a middleware 43, an application programming interface (API) 45, and/or an application program 47 (or an “application”). At least part of the kernel 41, the middleware 43, or the API 45 may be referred to as an operating system (OS).

The kernel 41 may control or manage, for example, system resources (e.g., the bus 110, the processor 120, or the memory 130, and the like) used to execute an operation or function implemented in the other programs (e.g., the middleware 43, the API 45, or the application program 47). Also, as the middleware 43, the API 45, or the application program 47 accesses a separate component of the electronic device 100, the kernel 41 may provide an interface which may control or manage system resources.

The middleware 43 may play a role as, for example, a go-between such that the API 45 or the application program 47 communicates with the kernel 41 to communicate data. Also, the middleware 43 may process one or more work requests received from the application program 47 in order of priorities. For example, the middleware 43 may provide priorities which may use system resources (the bus 110, the processor 120, or the memory 130, and the like) of the electronic device 100 to at least one of the application program 47. For example, the middleware 43 may perform scheduling or load balancing for the one or more work requests by processing the one or more work requests in order of the priorities provided to the at least one of the application program 47.

The API 45 may be, for example, an interface in which the application program 47 controls a function provided from the kernel 41 or the middleware 43. For example, the API 45 may include at least one interface or function (e.g., instruction) for file control, window control, image processing, or text control, and the like.

The pressure sensor 140 may be disposed on or under the display panel 160. At least one of various types, for example, a capacitive type, a piezoelectric type, and the like, may be applied to the pressure sensor 140. The pressure sensor 140 may collect pressure information corresponding to a pressure change in response to control of the processor 120. The pressure sensor 140 may send the collected pressure information to the processor 120. According to various embodiments of the present disclosure, the pressure sensor 140 may operate to be linked with operating the touch module 90. For example, if foreign substances of a predetermined size or more are in contact with the touch panel 180, the pressure sensor 140 may be activated. Alternatively, if contact regions where the foreign substances of the predetermined size or more are in contact with the touch panel 180 are a predetermined number or more of regions, the pressure sensor 140 may be activated. Alternatively, if a sensing value of foreign substances which are in contact with the touch panel 180 is changed, the pressure sensor 140 may be activated.

The input and output interface 150 may play a role as, for example, an interface which may transmit instructions or data input from a user or another external device to another component (or other components) of the electronic device 100. Also, input and output interface 150 may output instructions or data received from another component (or other components) of the electronic device 100 to the user or the other external device. The input and output interface 150 may provide, for example, reaction (e.g., vibration, a sound, lamp ON/OFF, and the like) according to touch invalidity processing, touch validity processing, foreign substance contact detection, and the like. In this regard, the input and output interface 150 may include an audio device, a vibration module, a lamp, and the like. According to an embodiment of the present disclosure, if a foreign substance contact region is detected, the input and output interface 150 may provide vibration or lamp ON/OFF of a pattern corresponding to a guide sound and guide information corresponding to the detected foreign substance contact region. If a touch operation occurs on a foreign substance contact region, the input and output interface 150 may output guide information corresponding to the corresponding operation. In connection with touch validity processing, the input and output interface 150 may output vibration of a predetermined pattern or a predetermined guide sound, and the like. The vibration, the guide sound, or the lamp ON/OFF, and the like may be omitted according to settings.

The display panel 160 may include, for example, a liquid crystal display (LCD), a light emitting diode (LED) display, an organic LED (OLED) display, a microelectromechanical systems (MEMS) display, or an electronic paper display. The display panel 160 may display, for example, a variety of content (e.g., text, images, videos, icons, or symbols, and the like) to the user. The display panel 160 may include, for example, the touch module 90. The display panel 160 including the touch module 90 may receive, for example, touch, gesture, proximity, or a hovering input using an electronic pen or part of a body of the user.

According to various embodiments of the present disclosure, the display panel 160 may display predetermined guide information. For example, the display panel 160 may display guide information including at least one of an image or text for a region which is in contact with foreign substances. Alternatively, the display panel 160 may display guide information about normal processing of a touch event which occurs in a state where foreign substances are in contact with it. According to various embodiments of the present disclosure, the display panel 160 may output information about a touch error which occurs in a state where foreign substances are in contact with it. Also, the display panel 160 may display guide information about a valid touch region which may perform normal processing, except for a region with which foreign substances are in contact with it.

The communication interface 170 may establish communication between, for example, the electronic device 100 and an external device (e.g., a first external electronic device 400, a second external electronic device 500, or a server 200). For example, the communication interface 170 may connect to a network 300 through wireless communication or wired communication and may communicate with the external device (e.g., the second external electronic device 500 or the server 200). The wireless communication may use, for example, at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), and the like as a cellular communication protocol. Also, the wireless communication may include, for example, local-area communication. The local-area communication may include, for example, at least one of wireless-fidelity (Wi-Fi) communication, Bluetooth (BT) communication, near field communication (NFC), or global navigation satellite system (GNSS) communication, and the like. The GNSS may include, for example, at least one of a global positioning system (GPS), a Glonass, a Beidou navigation satellite system (hereinafter referred to as a “Beidou”), or a Galileo (i.e., the European global satellite-based navigation system) according to an available area or a bandwidth, and the like. Hereinafter, the “GPS” used herein may be interchangeably with the “GNSS”. The wired communication may include at least one of, for example, universal serial bus (USB) communication, high definition multimedia interface (HDMI) communication, recommended standard 232 (RS-232) communication, or plain old telephone service (POTS) communication, and the like. The network 300 may include a telecommunications network, for example, at least one of a computer network (e.g., a local area network (LAN) or a wide area network (WAN)), the Internet, or a telephone network. The communication interface 170 may receive, for example, setting information or table information from the first and second external electronic devices 400 and 500 or the server device 200. The communication interface 170 may send the received information to the memory 130 or the processor 120. According to various embodiments of the present disclosure, the communication interface 170 may be activated by a touch signal generated by the touch module 90. For example, if the touch signal generated by the touch module 90 is a signal for activating an application associated with a communication function, the communication interface 170 may activate a predetermined communication channel.

The touch module 90 may support a touch function of the electronic device 100. The touch module 90 may be implemented according to, for example, at least one of various types such as a film type and a glass type. The touch module 90 may include, for example, the touch panel 180 and the touch control module 190.

For example, the touch panel 180 may be disposed abutting the display panel 160, on or under the display panel 160. The touch panel 180 may operate to be mapped with at least part of the display panel 160. As described with reference to FIGS. 1A to 5, this touch panel 180 may be implemented to operate the first touch type (e.g., a mutual capacitance sensor type) and the second touch type (e.g., a self-capacitance sensor type). The touch panel 180 may connect to the touch control module 190 and may provide a region sensed by a signal provided from the touch control module 190.

The touch control module 190 may provide a predetermined touch signal to the touch panel 180 and may collect a scan signal (or a sensing signal). According to an embodiment of the present disclosure, as described with reference to FIGS. 1A to 5, the touch control module 190 may collect first touch type information and second touch type information. The touch control module 190 may configure a mixing information table according to the collected first touch type information and the collected second touch type information and may detect a valid touch node. The touch control module 190 may collect coordinate information of the detected valid touch node and may send the collected coordinate information to the processor 120. Alternatively, the touch control module 190 may collect a coordinate of a touch (contact) point according to the first touch type information and may send the collected coordinate to the processor 120. Alternatively, the touch control module 190 may calculate a coordinate of a hovering point according to the second touch type information and may send the calculated coordinate to the processor 120.

According to various embodiments of the present disclosure, the touch control module 190 may alternately collect the first touch type information and the second touch type information in a constant period and may send the collected information to the processor 120. For example, the touch control module 190 may collect the first touch type information and the second touch type information per frame period and may send the collected information to the processor 120. In this operation, the touch control module 190 may alternately perform sensing according to the first touch type and sensing according to the second touch type within a period of one frame. Alternatively, the touch control module 190 may divide a period of one frame into two intervals, may perform the sensing according to the first touch type and the sensing according to the second touch type for each interval, and may collect the first touch type information and the second touch type information.

FIG. 6B is a drawing illustrating an analysis of a touch panel according to various embodiments of the present disclosure. An electronic device 100 of FIG. 6A may operate a foreign substance (e.g. waterdrops and the like) detection table 601. In this regard, the foreign substance detection table 601 may be stored in a memory 130 of FIG. 6A or may be provided from a server device 200 of FIG. 6A. The foreign substance detection table 601 may include, for example, values for performing touch type determination, touch validity determination, or touch invalidity determination according to first touch type information (e.g., information of nodes, which is collected according to a mutual capacitance type sensor circuit) and second touch type information (e.g., information of nodes, which is collected according to a self-capacitance type sensor circuit). As illustrated by table 601, if there is no first touch type information or the first touch type information denotes a capacitance change less than a first reference value (either of these resulting in an “X” condition) in the foreign substance detection table 601 and if there is no second touch type information or the second touch type information has less than a second reference value (X), a processor 120 of FIG. 6A may determine that there is no touch operation. (It is noted here that “first threshold” and “second threshold” may be used to refer to the first and second reference values, respectively.) If there is no first touch type information or the first touch type information has less than a first reference value (X) and if the second touch type information has the second reference value or more (O), the processor 120 may determine that a current state is a proximity state (e.g., a hovering state). If the first touch type information has the first reference value or more (O) and if there is no second touch type information or the second touch type information has less than the second reference value (X), the processor 120 may determine the current state as a foreign substance contact state (e.g., a water drop contact state). If the first touch type information has the first reference value or more (O) and if the second touch type information has the second reference value or more (O), the processor 120 may determine the current state as a real touch state by a finger or stylus of the user (denoted as “Finger” in Table 601).

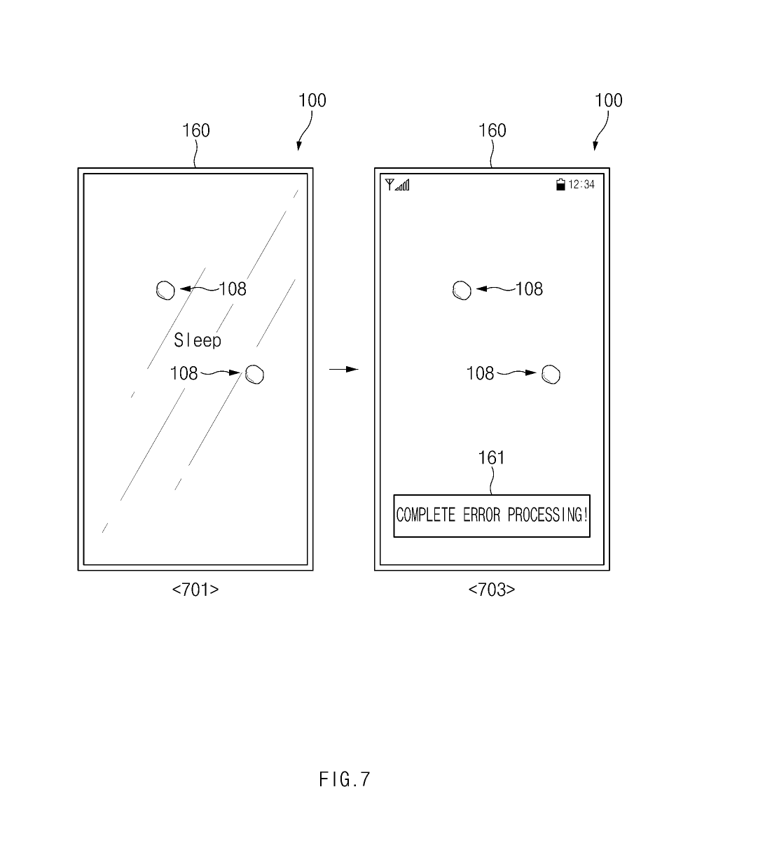

FIG. 7 is a drawing illustrating a screen interface according to operation of a touch panel according to various embodiments of the present disclosure. In this example, a display panel 160 of an electronic device 100 of FIG. 6A may be in state 701. For example, the display panel 160 of the electronic device 100 may be in a state where power supply is stopped. Also, the display panel 160 of the electronic device 100 may be in a state where power supply of a touch panel 180 of FIG. 6A, disposed on (or under) the display panel, is stopped. Electronic device 100 may stop supplying power to the display panel 160 and the touch module 90 in a sleep state. Alternatively, the electronic device 100 may stop supplying power to the display panel 160 and the touch module 90 in response to a power key input signal. Foreign substances 180 (e.g., water or a conductive material) may be present at a constant size on a front surface, e.g., transparent plate, of electronic device 100, where the transparent plate may be considered part of the display panel 160 or the touch panel 180, depending on a layered construction. The following example will assume that the touch panel 180 forms part of the front surface of the electronic device 100. For instance, the foreign substances 180 may be in contact with the touch panel 180 as a result of rain, a user's sweat or use of water after washing or drinking, or in various other situations.

According to an embodiment of the present disclosure, a turn-on event may occur in a state where the foreign substances 108 are in contact with the touch panel 180 (where the turn-on event is not caused by a false touch detection of the foreign substances 108). For example, power may be supplied to the touch module 90 and the display panel 160 by an input signal of a home key or a power key, and the like. A turn-on event may also occur in response to information (e.g., a call connection request signal and a message receiving signal) received from first and second external electronic devices 400 and 500 or a server device 200 of FIG. 6A. A turn-on event may also occur by predetermined scheduling (e.g., alarm setting and the like).

If the turn-on event occurs, the display panel 160 of the electronic device 100 may output a predetermined screen in state 703. The predetermined screen may be, for example, a home screen, a waiting screen, or a predetermined application execution screen. The foreign substances 108 may continuously maintain a corresponding position in a state where the display panel 160 is turned on. The processor 120 of the electronic device 100 may perform an initialization process in response to the turn-on event of the touch panel 180. In this operation, the processor 120 of the electronic device 100 may determine a state, where the foreign substances 108 are present on the touch panel 180, according to a normal state sensing value table stored in the memory 130. Therefore, the processor 120 may not process a state of the touch panel 180, on which the foreign substances 108 are present, as a reference state and may process the state of the touch panel 180, on which the foreign substances 108 are present, as the state where the foreign substances 108 are present.

If the turn-on event occurs, the processor 120 may request a touch control module 190 of FIG. 6A to initialize the touch panel 180. In this case, the touch control module 190 may determine a state, where the foreign substances 108 are present, using a normal state sensing value table stored in a buffer 194 of FIG. 6A. The processor 120 (or the touch control module 190) may analyze a position of the foreign substances 108 may complete error processing according to distribution of the foreign substances 108 according to the analyzed position. The processor 120 may control the display panel 160 to output, for example, guide information 161 according to error processing.

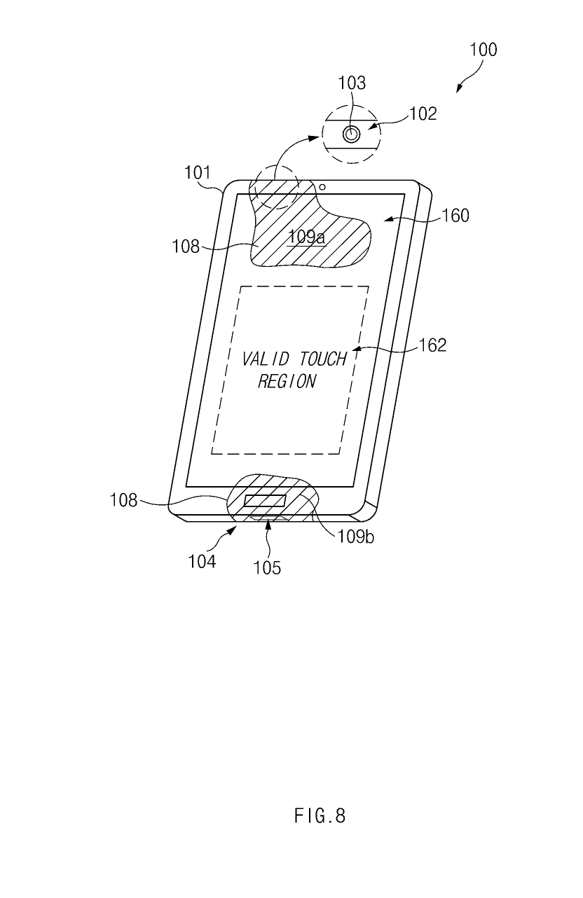

FIG. 8 is a drawing illustrating an electronic device in an example operating environment, according to various embodiments of the present disclosure. Electronic device 100, which is schematically illustrated in FIG. 6A, may include a housing 101 and a user interface (e.g., a display panel 160, a touch module 90 of FIG. 6A, a home button, and the like). The housing 101 may have, for example, various sizes or shapes according to a type of the electronic device 100. In FIG. 8, an embodiment of the present disclosure is exemplified with the housing 101 having a generally rectangular form with at least some of its corners rounded. The display panel 160 and a touch panel 180 of FIG. 6A may be exposed through one side of the housing 101. For example, a front surface of the housing 101 may be the form of covering edges of the display panel 160 and the touch panel 180, the latter acting as a transparent plate. According to various embodiments of the present disclosure, the housing 101 may be implemented with a “holeless” or “hole-free” type to support a waterproof function. For example, the housing 101 may include an earphone insertion hole 102 disposed at its upper side and a first waterproof member 103 removably connected to the earphone insertion hole 102. At least a part of the first waterproof member 103 may be made of materials, such as rubber materials and polyurethane materials, which may have a constant elasticity and may play a damp-proof or dustproof role. Also, a connector insertion hole 104 and a second waterproof member 105 may be disposed at one side of the housing 101. At least part of the second waterproof member 105 may be made of rubber materials or polyurethane materials, and the like. A central panel of the second waterproof member 105 may be made of materials, for example, plastic or metal, which are similar to those of the housing around the central panel. A gasket of elastic and waterproof materials may be disposed in a peripheral portion of the central panel, where the gasket may be in a position facing a peripheral portion of the connector insertion hole 104. The home button may be made of plastic or metal materials of a constant thickness. A gasket of elastic and waterproof materials may be disposed in a process when the home button is inserted into the housing 101 to have waterproof, damp-proof, and dustproof functions.

The touch panel 180 may be disposed on the display panel 160, in which case the touch panel may define a part of the front surface of electronic device 100, or under the display panel 160, i.e., which may be considered behind the display panel or in a common layer as the display panel 160, such as integrated with the display panel 160. As shown in FIG. 8, a first foreign substance region 109a of a first size, a second foreign substance region 109b of a second size, and the like may be disposed on the device 100's front surface. Foreign substances may be, for example, water, ink, or a conductive liquid substance, and the like. If the foreign substances are disposed on the device 100's front surface, a corresponding foreign substance region may be detected on the touch panel 180 while the touch panel 180 is sensed by a mutual capacitance type sensor. For example, the first foreign substance region 109a and the second foreign substance region 109b may be detected in a process of obtaining first touch type information. Also, the first foreign substance region 109a and the second foreign substance region 109b may not be detected while sensed by a self-capacitance type sensor. That is, regions 109a, 109b may be detected to be “untouched regions” by the self-capacitance type sensor. Therefore, second touch type information may not include a node of a predetermined second reference value or more (e.g., a reference value or more which may be recognized by occurrence of a touch).

The electronic device 100 may detect the first foreign substance region 109a and the second foreign substance region 109b according to the first touch type information and may output, as shown in FIG. 8, guide information about a valid touch region 162 according to the first foreign substance region 109a and the second foreign substance region 109b. Alternatively, if the first foreign substance region 109a of a predetermined size or more or the second foreign substance region 109b of a predetermined size or more is generated, the electronic device 100 may automatically activate a pressure sensor 140 of FIG. 6A. Therefore, after the first foreign substance region 109a or the second foreign substance region 109b is generated, the electronic device 100 may process a touch operation using a pressure-based method. Alternatively, the electronic device 100 may store region detection data for the first foreign substance region 109a or the second foreign substance region 109b and may calculate a touch point according to a change of capacitance by a touch generated later.

As described above, in a pool, a bathhouse, a shoreline, or a riverside, and the like where foreign substances larger than a threshold size are in contact with the display panel or the touch panel, although the foreign substance of at least the threshold size are in contact with the display panel or the touch panel, the electronic device 100 may provide proper guide information or may perform error processing to guide the user to normally use the electronic device 100.

As described above, according to various embodiments of the present disclosure, an electronic device may include an external housing configured to include a transparent plate, a display panel, at least part of which are exposed through the transparent plate, a touch panel configured to be disposed in the external housing, a memory, and a processor configured to electrically connect to the memory. The memory may store instructions set, when executed by the processor, such that the processor receives first data including an input sensed by a first type through the touch panel, receives second data including an input sensed by a second type different from the first type through the touch panel, compares the first data with the second data, and determines whether an object is in direct contact with at least part of the display panel, whether the object is close within a selected distance or is not in contact with at least part of the display panel, or whether fluids are in contact with at least part of the display panel, based on at least part of the compared result.

According to various embodiments, an electronic device may include: an external housing including a transparent plate forming a front surface of the electronic device; a display panel, at least part of which is exposed through the transparent plate; a touch panel adjacent the display panel; a memory; and a processor operably coupled to the memory. The memory may store instructions which, when executed by the processor, cause the processor to: receive first data including an input sensed by a first sensor of a first type through the touch panel, and receive second data including an input sensed by a second sensor of a second type through the touch panel, compare the first data with the second data to generate a comparison result, and determine whether an object detected using at least one of the first or second sensors is a foreign object in direct contact with the transparent plate, based on at least part of the comparison result.

In various embodiments, the first sensor may be a mutual-capacitance type sensor while the second sensor may be a self-capacitance type sensor. The mutual-capacitance type sensor may be designated for detecting direct touch inputs while the self-capacitance type sensor may be designated for detecting hovering inputs. The foreign object may be a fluidic object.

According to various embodiments of the present disclosure, the touch panel may include first conductive lines configured to be extended in a first direction and second conductive lines configured to be extended in a second direction intersecting the first direction and to intersect the first conductive lines. The touch panel may sequentially or simultaneously provide a signal to the first conductive lines and may sense a change of the signal in the second conductive lines, in the first type. The touch panel may sequentially or simultaneously provide a signal to each of the first conductive lines and the second conductive lines and may sense a change of the provided signal, in the second type.

According to various embodiments of the present disclosure, the instructions may be set such that the processor determines that the object is in direct contact with at least part of the touch panel, if an input sensed by the first type through the at least part of the touch panel has a first reference value or more and if an input sensed by the second type through the at least part of the touch panel has a second reference value or more.

According to various embodiments of the present disclosure, the instructions may be set such that the processor determines that foreign substances are in contact with at least part of the touch panel, if an input sensed by the first type through the at least part of the touch panel has a first reference value or more and if an input sensed by the second type through the at least part of the touch panel has less than a second reference value.

According to various embodiments of the present disclosure, the instructions may be set such that the processor determines that a touch object hovers above at least part of the touch panel, if an input sensed by the first type through the at least part of the touch panel has less than a first reference value and if an input sensed by the second type through the at least part of the touch panel has a second reference value or more.

According to various embodiments of the present disclosure, an electronic device may include a display panel, a touch module configured to include a touch panel, at least part of which is disposed on the display panel, and a touch control module, a memory, and a processor configured to electrically connect to the touch module and the memory. The memory may store instructions set, when executed by the processor, such that the processor collects first touch type information and second touch type information within a period of one frame displayed on the display panel and determines a region, where first touch type information of a first reference value or more and second touch type information of a second reference value or more are overlapped and detected, as a valid touch region according to the collected first touch type information and the collected second touch type information.

According to various embodiments of the present disclosure, the instructions may be set such that the processor cancels detected points, having a sensing value in which the second touch type information has less than a second reference value, among detected points having a sensing value in which the first touch type information has a first reference value or more.

According to various embodiments of the present disclosure, the instructions may be set such that the processor performs sensing according to a first touch type a first predetermined number of times during a constant period within a period of one frame and performs sensing according to a second touch type a second predetermined number of times during a constant period.

According to various embodiments of the present disclosure, the instructions may be set such that the processor alternately perform sensing according to a first touch type associated with collecting the first touch type information and sensing according to a second touch type associated with collecting the second touch type information during a constant period.

According to various embodiments of the present disclosure, the instructions may be set such that the processor repeatedly calculates a touch point during a period when every frame is displayed according to touch type information collected after alternately performing sensing according to a first touch type associated with the first touch type information and sensing according to a second touch type associated with collecting the second touch type information.

According to various embodiments of the present disclosure, the instructions may be set such that the processor calculates a touch point according to touch type information collected after performing sensing according to a first touch type and sensing according to a second touch type, which are performed in an actually identical way within a period when the one frame is displayed.

According to various embodiments of the present disclosure, the instructions may be set such that the processor activates a pressure sensor and determines a valid touch point, if each of regions of first touch type information of the first reference value or more and second touch type information of less than the second reference value has a predetermined size or more.

According to various embodiments of the present disclosure, the instructions may be set such that the processor activates a pressure sensor and determines a valid touch point, if a constant region of first touch type information of the first reference value or more and a constant region of less than the second reference value are a predetermined number or more of regions.

According to various embodiments of the present disclosure, the instructions may be set such that the processor activates a pressure sensor and determines a valid touch point, if second touch type information among first touch type information of the first reference value or more has less than the second reference value and then has the second reference value or more at a specific time.

According to various embodiments of the present disclosure, the memory may store a normal touch sensing value distribution table generated according to first touch type information and second touch type information in a state where foreign substances are not in contact with the display panel or the touch panel.

According to various embodiments of the present disclosure, the instructions may be set such that the processor determines whether foreign substances are in contact with the display panel or the touch panel according to the normal touch sensing value distribution table in a process of initializing the touch panel.

According to various embodiments of the present disclosure, the instructions may be set such that the processor determines a corresponding node as a foreign substance contact region, if a change of touch capacitance at a node of touch type information having a sensing value of a constant level or more among collected touch type information is within a predetermined range during a predetermined time.

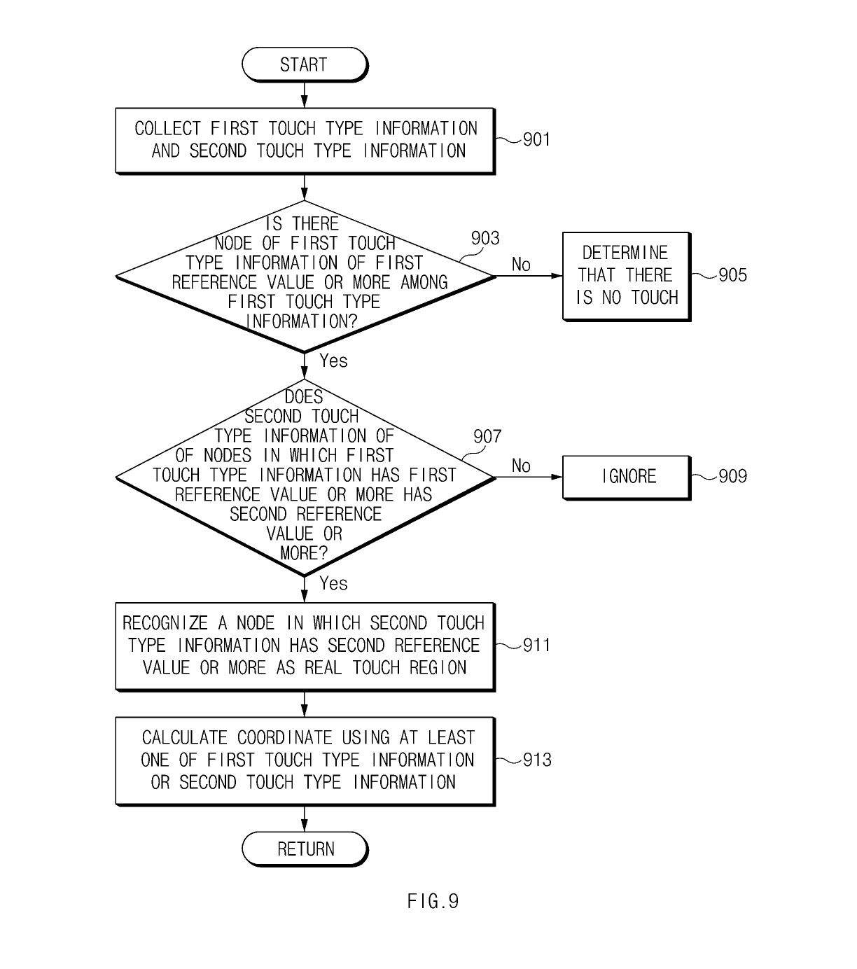

FIG. 9 is a flowchart illustrating a method for operating a touch module of an electronic device according to various embodiments of the present disclosure. In operation 901, a processor 120 (or a touch control module 190) of FIG. 6A may collect first touch type information and second touch type information. For example, the processor 120 may collect touch type information generated by sensing according to a first touch type and sensing according to a second touch type, which are performed at least once or more within a period of every frame. A plurality of sensing according to the first touch type and a plurality of sensing according to the second touch type may be performed within one frame. Therefore, the processor 120 may generate a plurality of first touch type information and a plurality of second touch type information. In this case, the processor 120 may collect the plurality of first touch type information to generate one set of first touch type information. Also, the processor 120 may collect the plurality of second touch type information to generate one set of second touch type information. The number of times sensing according to the touch type is performed may be a predetermined number of times in connection with processing an error. Also, the sensing according to the first touch type and the sensing according to the second touch type may be performed the same number of times within a period of one frame. It is noted here that the first reference value and second reference value in the example of FIG. 9 may be interchangeably referred to as first and second thresholds, respectively.

In operation 903, processor 120 may determine whether there is a node of first touch type information of a first reference value or more among the first touch type information (e.g., a specific point of a touch panel, a sensing electrode of the touch panel, or a crossing point of a transmit electrode and a receive electrode of the touch panel). If there is no node of the first touch type information of the first reference value or more among the first touch type information, in operation 905, the processor 120 may determine that there is no touch. If there is no node of the first touch type information of the first reference value or more among the first touch type information and if second touch type information has a second reference value or more, the processor 120 may recognize a current event as a hovering event. In this case, the processor 120 may process a touch function according to occurrence of the hovering event.

If there is the node of the first touch type information of the first reference value or more among the first touch type information, in operation 907, the processor 120 may determine whether second touch type information of nodes corresponding to at least one first touch type information of the first reference value or more has the second reference value or more. If second touch type information of a node where the first touch type information has the first reference value or more is less than the second reference value, in operation 909, the processor 120 may ignore the corresponding node. Alternatively, the processor 120 may determine the corresponding node as a foreign substance contact region and may cancel the corresponding node.

If the second touch type information of the node where the first touch type information has the first reference value or more has the second reference value or more, in operation 911, the processor 120 may recognize a node, where the second touch type information has the second reference value or more, as a real touch region. In operation 913, the processor 120 may calculate a coordinate according to at least one of first touch type information or second touch type information of the node recognized as the real touch region. Processor 120 may calculate a coordinate corresponding to a real touch according to first touch type information corresponding to a mutual capacitance type. Also, the processor 120 may calculate a coordinate corresponding to a hovering touch according to second touch type information corresponding to a self-capacitance type. The processor 120 may calculate a coordinate, corresponding to a point which is in contact with foreign substances, according to the second touch type information. The processor 120 may change a screen or may control execution of a function in response to occurrence of a corresponding touch according to touch information obtained according to the calculation of the coordinate.

Meanwhile, embodiments of the present disclosure have been exemplified as the above-mentioned operations are described using operations of the processor 120. However, in other embodiments, the above-mentioned methods for operating the touch module may correspond to operations of a touch control module 190.

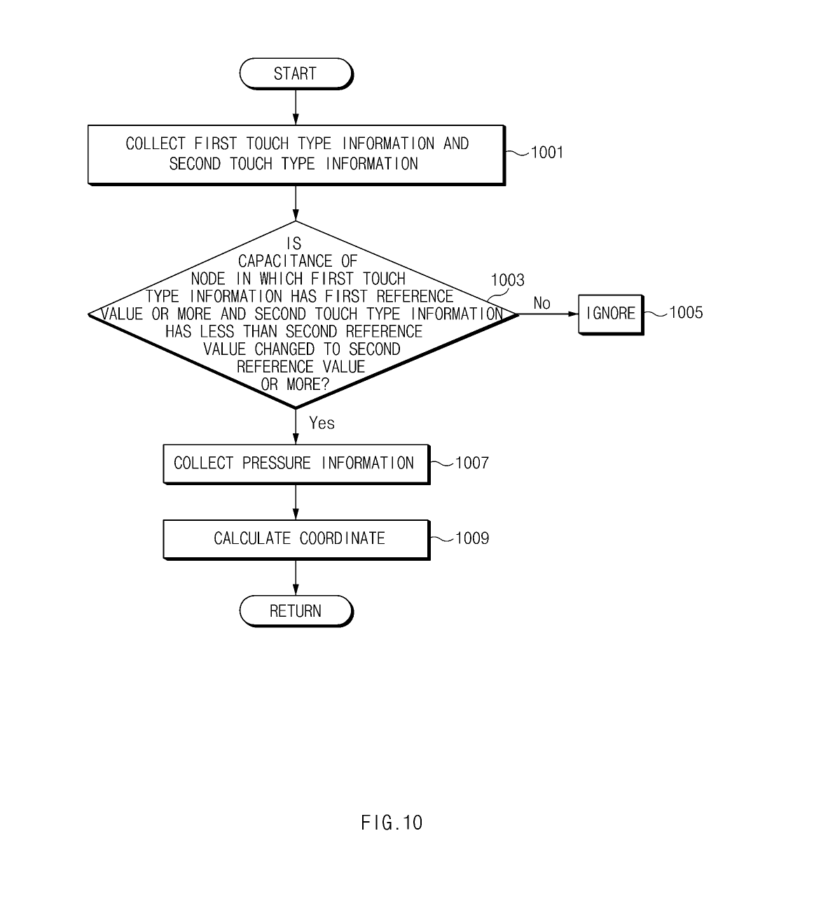

FIG. 10 is a flowchart illustrating a touch operation method of an electronic device according to various embodiments of the present disclosure. In operation 1001, a processor 120 of FIG. 6A may collect first touch type information and second touch type information. For example, the processor 120 may collect first touch type information (e.g., mutual capacitance sensing value information of nodes included in a touch panel 180 of FIG. 6A) at least once during a predetermined period. Also, the processor 120 may collect second touch type information (e.g., self-capacitance sensing value information of nodes included in the touch panel 180) at least once in a period after or before collecting the first touch type information.

In operation 1003, the processor 120 may determine whether capacitance of a node where the first touch type information has a first reference value or more and where the second touch type information has less than a second reference value is changed to the second reference value or more. If the capacitance of the node is not changed, in operation 1005, the processor 120 may ignore the corresponding node (e.g., perform touch invalidity processing).

If the capacitance of the node is changed to the second reference value or more, in operation 1007, the processor 120 may collect pressure information. In this regard, the processor 120 may activate a pressure sensor 140 of FIG. 6A. The processor 120 may collect pressure information using the activated pressure sensor 140. In this operation, the processor 120 may partially collect pressure information. For example, if the pressure sensor 140 is independently disposed on a cell-by-cell basis, the processor 120 may collect only pressure information about pressure sensing cells in a predetermined region located around the node where the first touch type information has the first reference value or more and where the second touch type information has less than the second reference value. In operation 1009, the processor 120 may calculate a touch coordinate.

An embodiment of the present disclosure is exemplified as the processor 120 activates the pressure sensor 140 according to a change of capacitance of a specific node. However, the scope and spirit of the present disclosure may not be limited thereto. According to various embodiments of the present disclosure, the processor 120 may collect information about a size of a foreign substance region or the number of foreign substance regions of a constant size or more. In this regard, the processor 120 may verify a size of a foreign substance region (e.g., distribution of nodes of a constant reference value or more) using collected first touch type information and collected second touch type information. If a change of capacitance of nodes predicted as a foreign substance region is kept constant during a predetermined time, the processor 120 may determine the nodes as the foreign substance region. The processor 120 may activate the pressure sensor 140 in response to detecting a foreign substance region of a constant size or more or a predetermined number of foreign substance regions.

As described above, according to various embodiments of the present disclosure, a method for operating an electronic device may include receiving first data including an input sensed by a firs type, through a touch panel, receiving second data including an input sensed by a second type different from the first type, through the touch panel, comparing the first data with the second data, and determining whether an object is in direct contact with at least part of a display panel, whether the object is close within a selected distance or is not in contact with the at least part of the display panel, or whether fluids are in contact with the at least part of the display panel, based on at least part of the compared result.

According to various embodiments of the present disclosure, the receiving of the first data may include sequentially or simultaneously providing a signal to first conductive lines and sensing a change of the signal in second conductive lines in the touch panel including the first conductive lines extended in a first direction and the second conductive lines. The receiving of the second data may include sequentially or simultaneously providing a signal to each of the first conductive lines and the second conductive lines and sensing a change of the provided signal.

According to various embodiments of the present disclosure, the receiving of the second data may include sensing an input from one of the first conductive lines and all of the second conductive lines and sensing an input from another of the first conductive lines and all of the second conductive lines.

According to various embodiments of the present disclosure, the determining may include one of determining that an object is in direct contact with at least part of the touch panel if an input sensed by the first type through the at least part of the touch panel has a first reference value or more and if an input sensed by the second type through the at least part of the touch panel has a second reference value or more, determining that foreign substances are in contact with at least part of the touch panel if an input sensed by the first type through the at least part of the touch panel has the first reference value or more and if an input sensed by the second type through the at least part of the touch panel has less than the second reference value, and determining that a touch object hovers above at least part of the touch panel if an input sensed by the first type through the at least part of the touch panel has less than the first reference value and if an input sensed by the second type through the at least part of the touch panel has the second reference value or more.

As described above, according to various embodiments of the present disclosure, a method for operating an electronic device may include collecting first touch type information and second touch type information from a touch module within a period of one frame displayed on a display panel and determining a region, where first touch type information of a first reference value or more and second touch type information of second reference value or more are overlapped and detected, as a valid touch region according to the collected first touch type information and the collected second touch type information.

According to various embodiments of the present disclosure, the method may further include cancelling detected nodes having a sensing value, where the second touch type information has less than the second reference value, among detected nodes having a sensing value where the touch type information has the first reference value or more.

According to various embodiments of the present disclosure, the collecting of the first touch type information and the second touch type information may include one of performing sensing according to a first touch type a first predetermined number of times during a constant period within the period of the one frame and performing sensing according to a second touch type a second predetermined number of times during a constant period within the period of the one frame and alternately performing the sensing according to the first touch type associated with the first touch type information and the sensing according to the second touch type associated with collecting the second touch type information during a constant period.

According to various embodiments of the present disclosure, the determination of the region as the valid touch region may include determining a valid touch region according to touch type information collected after performing sensing according to a first touch type and sensing according to a second touch type performed in an actually identical way within a period when the one frame is displayed.

According to various embodiments of the present disclosure, the collecting of the first touch type information and the second touch type information may include repeatedly calculate a touch node during a period when every frame is displayed according to touch type information collected after alternately performing sensing according to a first touch type associated with collecting the first touch type information and sensing according to a second touch type associated with the second touch type information.

According to various embodiments of the present disclosure, the method may further include one of activating a pressure sensor and determining a valid touch node if each of regions of a first touch type information of the first reference value or more and second touch type information of less than the second reference value has a predetermined size or more, activating the pressure sensor and determining a valid touch node if a constant region of the first touch type information of the first reference value or more and a constant region of the second touch type information of less than the second reference value are a predetermined number of regions, and activating the pressure sensor and determining a valid touch node if second touch information among the first touch type information of the first reference value or more has less than the second reference value and then has the second reference value or more at a specific time.

According to various embodiments of the present disclosure, the method may further include determining whether foreign substances are in contact with the display panel in a process of initializing a touch module according to a normal touch sensing value distribution table corresponding to first touch type information and second touch type information in a state where the foreign substances are not in contact with the display panel.

According to various embodiments of the present disclosure, the method may further include determining a corresponding node as a foreign substance contact region if a change of touch capacitance at a node of touch type information, having a sensing value of a constant level or more, among collected touch type information is within a predetermined range during a predetermined time

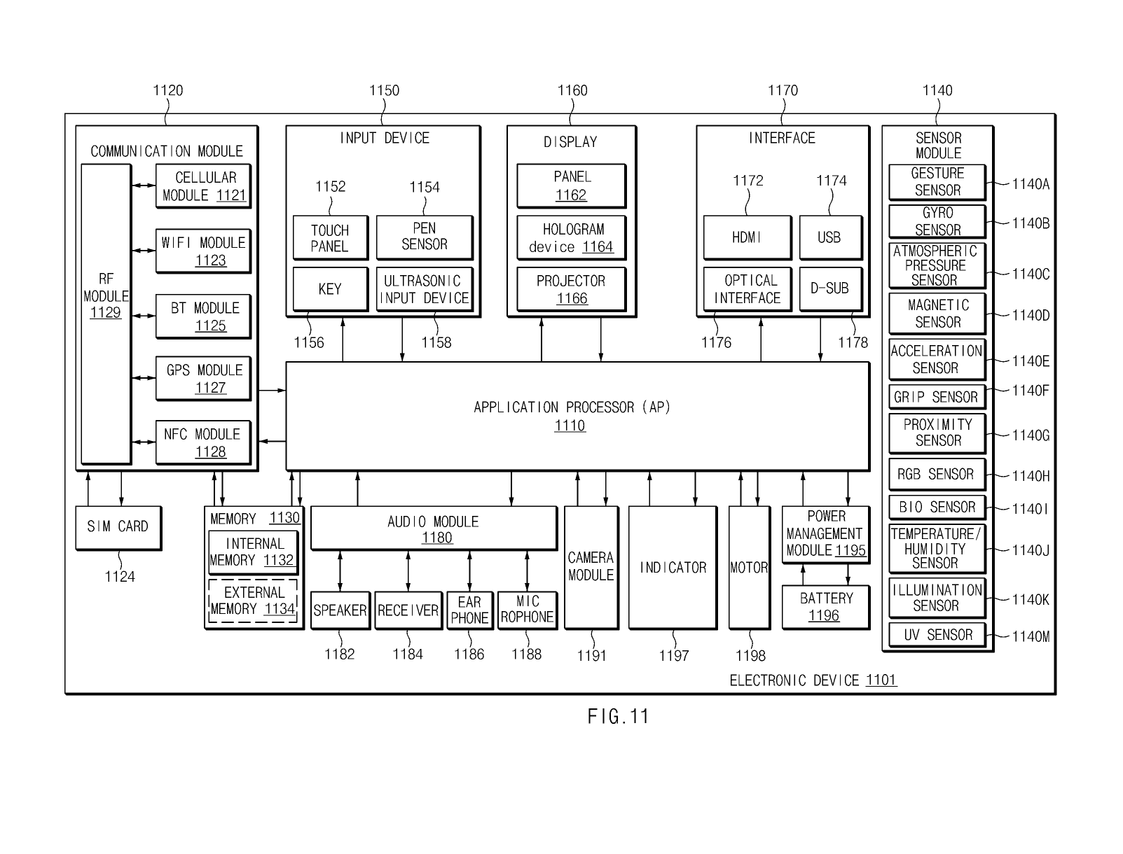

FIG. 11 is a block diagram illustrating a configuration of an electronic device according to various embodiments of the present disclosure.

Referring to FIG. 11, an electronic device 1100 may include, for example, all or part of an electronic device 100 shown in FIG. 6A. The electronic device 1100 may include one or more processors 1110 (e.g., application processors (APs)), a communication module 1120, a subscriber identification module (SIM) 1124, a memory 1130, a sensor module 1140, an input device 1150, a display 1160, an interface 1170, an audio module 1180, a camera module 1191, a power management module 1195, a battery 1196, an indicator 1197, and a motor 1198.

The processor 1110 may drive, for example, an operating system (OS) or an application program to control a plurality of hardware or software components connected thereto and may process and compute a variety of data. The processor 1110 may be implemented with, for example, a system on chip (SoC). According to an embodiment of the present disclosure, the processor 1110 may further include a graphic processing unit (GPU) (not shown) and/or an image signal processor (not shown). The processor 1110 may include at least some (e.g., a cellular module 1121) of the components shown in FIG. 11. The processor 1110 may load instructions or data received from at least one of other components (e.g., a non-volatile memory) to a volatile memory to process the data and may store various data in a non-volatile memory.

The communication module 1120 may have the same or similar configuration as or to that of a communication interface 170 of FIG. 6A. The communication module 1120 may include, for example, the cellular module 1121, a wireless-fidelity (Wi-Fi) module 1123, a Bluetooth (BT) module 1125, a global navigation satellite system (GNSS) module 1127 (e.g., a GPS module, a Glonass module, a Beidou module, or a Galileo module), a near field communication (NFC) module 1128, and a radio frequency (RF) module 1129.

The cellular module 1121 may provide, for example, a voice call service, a video call service, a text message service, or an Internet service, and the like through a communication network. According to an embodiment of the present disclosure, the cellular module 1121 may identify and authenticate the electronic device 1100 in a communication network using the SIM 1124 (e.g., a SIM card). According to an embodiment of the present disclosure, the cellular module 1121 may perform at least part of functions which may be provided by the processor 1110. According to an embodiment of the present disclosure, the cellular module 1121 may include a communication processor (CP).

The Wi-Fi module 1123, the BT module 1125, the GNSS module 1127, or the NFC module 1128 may include, for example, a processor for processing data transmitted and received through the corresponding module. According to various embodiments of the present disclosure, at least some (e.g., two or more) of the cellular module 1121, the Wi-Fi module 1123, the BT module 1125, the GNSS module 1127, or the NFC module 1128 may be included in one integrated chip (IC) or one IC package.

The RF module 1129 may transmit and receive, for example, a communication signal (e.g., an RF signal). Though not shown, the RF module 1129 may include, for example, a transceiver, a power amplifier module (PAM), a frequency filter, or a low noise amplifier (LNA), or an antenna, and the like. According to another embodiment of the present disclosure, at least one of the cellular module 1121, the Wi-Fi module 1123, the BT module 1125, the GNSS module 1127, or the NFC module 1128 may transmit and receive an RF signal through a separate RF module.

The SIM 1124 may include, for example, a card which includes a SIM and/or an embedded SIM. The SIM 1124 may include unique identification information (e.g., an integrated circuit card identifier (ICCID)) or subscriber information (e.g., an international mobile subscriber identity (IMSI)).

The memory 1130 (e.g., a memory 130 of FIG. 6A) may include, for example, an embedded memory 1132 or an external memory 1134. The embedded memory 1132 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 1134 may further include a flash drive, for example, a compact flash (CF), a secure digital (SD), a micro-SD, a mini-SD, an extreme digital (xD), or a memory stick, and the like. The external memory 934 may functionally and/or physically connect with the electronic device 1100 through various interfaces.

The sensor module 1140 may measure, for example, a physical quantity or may detect an operation state of the electronic device 1100, and may convert the measured or detected information to an electric signal. The sensor module 1140 may include at least one of, for example, a gesture sensor 1140A, a gyro sensor 1140B, a barometric pressure sensor 1140C, a magnetic sensor 1140D, an acceleration sensor 1140E, a grip sensor 1140F, a proximity sensor 1140G, a color sensor 1140H (e.g., red, green, blue (RGB) sensor), a biometric sensor 1140I, a temperature/humidity sensor 1140J, an illumination sensor 1140K, or an ultraviolet (UV) sensor 1140M. Additionally or alternatively, the sensor module 1140 may further include, for example, an e-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), and/or a fingerprint sensor (not shown), and the like. The sensor module 1140 may further include a control circuit for controlling at least one or more sensors included therein. According to various embodiments of the present disclosure, the electronic device 1100 may further include a processor configured to control the sensor module 1140, as part of the processor 1110 or to be independent of the processor 1110. While the processor 1110 is in a sleep state, the electronic device 1100 may control the sensor module 940.

The input device 1150 may include, for example, a touch panel 1152, a (digital) pen sensor 1154, a key 1156, or an ultrasonic input unit 1158. The touch panel 1152 may recognize a touch input using at least one of, for example, a capacitive detecting method, a resistive detecting method, an infrared detecting method, or an ultrasonic detecting method. Also, the touch panel 1152 may further include a control circuit. The touch panel 1152 may further include a tactile layer and may provide a tactile reaction to a user.

The (digital) pen sensor 1154 may be, for example, part of the touch panel 1152 or may include a separate sheet for recognition. The key 1156 may include, for example, a physical button, an optical key, or a keypad. The ultrasonic input unit 1158 may allow the electronic device 1100 to detect a sound wave using a microphone (e.g., a microphone 1188) and to verify data through an input tool generating an ultrasonic signal.

The display module 1160 (e.g., a display panel 160 or a touch module 90 of FIG. 6A) may include a panel 1162, a hologram device 1164, or a projector 1166. The panel 1162 may include the same or similar configuration as or to that of the display panel 160 and the touch module 90. The panel 1162 may be implemented to be, for example, flexible, transparent, or wearable. The panel 1162 and the touch panel 1152 may be integrated into one module. The hologram device 1164 may show a stereoscopic image in a space using interference of light. The projector 1166 may project light onto a screen to display an image. The screen may be positioned, for example, inside or outside the electronic device 1100. According to an embodiment of the present disclosure, the display 1160 may further include a control circuit for controlling the panel 1162, the hologram device 1164, or the projector 1166.

The interface 1170 may include, for example, a high-definition multimedia interface (HDMI) 1172, a universal serial bus (USB) 1174, an optical interface 1176, or a D-subminiature 1178. The interface 1170 may be included in, for example, a communication interface 170 shown in FIG. 6A. Additionally or alternatively, the interface 1170 may include, for example, a mobile high definition link (MHL) interface, an SD card/multimedia card (MMC) interface, or an infrared data association (IrDA) standard interface.

The audio module 1180 may convert a sound and an electric signal in dual directions. At least part of components of the audio module 1180 may be included in, for example, an input and output interface 150 shown in FIG. 6A. The audio module 1180 may process sound information input or output through, for example, a speaker 1182, a receiver 1184, an earphone 1186, or the microphone 1188, and the like.

The camera module 1191 may be a device which captures a still image and a moving image. According to an embodiment of the present disclosure, the camera module 1191 may include one or more image sensors (not shown) (e.g., a front sensor or a rear sensor), a lens (not shown), an image signal processor (ISP) (not shown), or a flash (not shown) (e.g., an LED or a xenon lamp).

The power management module 1195 may manage, for example, power of the electronic device 1100. According to an embodiment of the present disclosure, though not shown, the power management module 1195 may include a power management integrated circuit (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 1196 and voltage, current, or temperature thereof while the battery 1196 is charged. The battery 1196 may include, for example, a rechargeable battery or a solar battery.

The indicator 1197 may display a specific state of the electronic device 1100 or part (e.g., a processor 120 of FIG. 6A) thereof, for example, a booting state, a message state, or a charging state, and the like. The motor 1198 may convert an electric signal into mechanical vibration and may generate vibration or a haptic effect, and the like. Though not shown, the electronic device 1100 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a mediaFlo™ standard, and the like.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

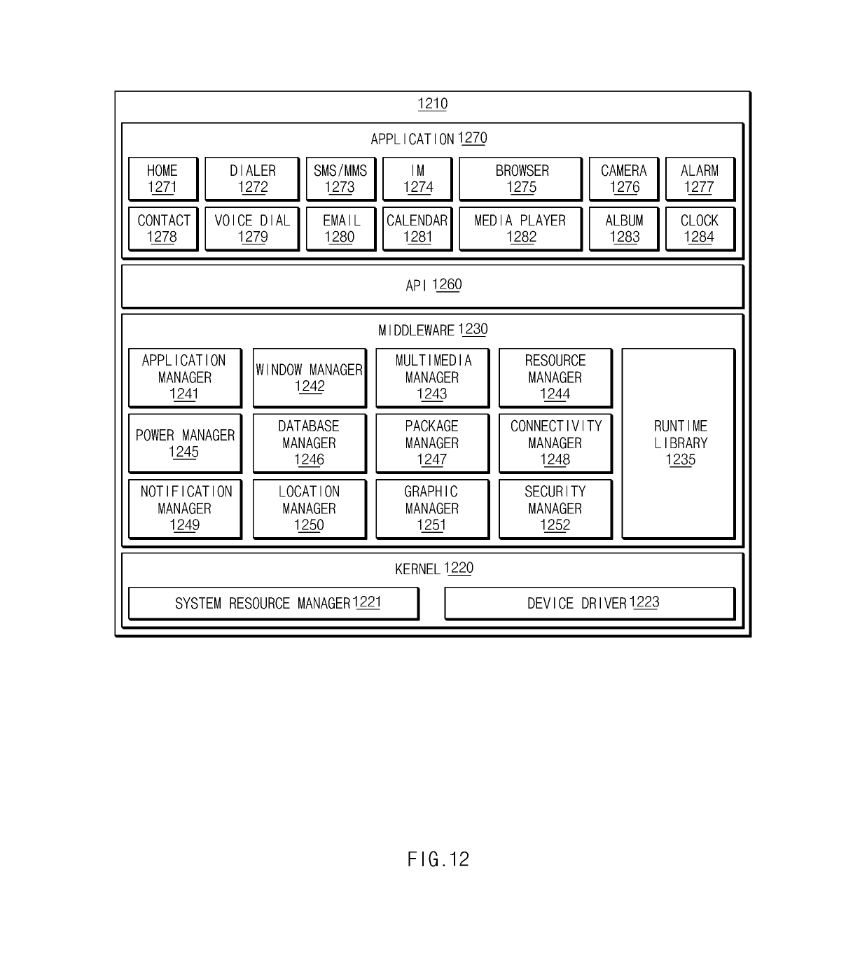

FIG. 12 is a block diagram illustrating a configuration of a program module according to various embodiments of the present disclosure.

Referring to FIG. 12, according to an embodiment of the present disclosure, the program module 1210 (e.g., a program 40 of FIG. 6A) may include an operating system (OS) for controlling resources associated with an electronic device (e.g., an electronic device 100 of FIG. 6A) and/or various applications (e.g., an application program 47 of FIG. 6A) which are executed on the OS. The OS may be, for example, Android, iOS, Windows, Symbian, Tizen, or Bada, and the like.

The program module 1210 may include a kernel 1220, a middleware 1230, an application programming interface (API) 1260, and/or an application 1270. At least part of the program module 1210 may be preloaded on the electronic device, or may be downloaded from an external electronic device (e.g., first and second external electronic devices 400 and 500, a server device 200, and the like of FIG. 6A).

The kernel 1220 (e.g., a kernel 41 of FIG. 6A) may include, for example, a system resource manager 1221 and/or a device driver 1223. The system resource manager 1221 may control, assign, or collect, and the like system resources. According to an embodiment of the present disclosure, the system resource manager 1221 may include a process management unit, a memory management unit, or a file system management unit, and the like. The device driver 1223 may include, for example, a display driver, a camera driver, a Bluetooth (BT) driver, a shared memory driver, a universal serial bus (USB) driver, a keypad driver, a wireless-fidelity (Wi-Fi) driver, an audio driver, or an inter-process communication (IPC) driver.

The middleware 1230 (e.g., a middleware 43 of FIG. 6A) may provide, for example, functions the application 1270 needs in common, and may provide various functions to the application 1270 through the API 1260 such that the application 1270 efficiently uses limited system resources in the electronic device. According to an embodiment of the present disclosure, the middleware 1230 (e.g., the middleware 43) may include at least one of a runtime library 1235, an application manager 1241, a window manager 1242, a multimedia manager 1243, a resource manager 1244, a power manager 1245, a database manager 1246, a package manager 1247, a connectivity manager 1248, a notification manager 1249, a location manager 1250, a graphic manager 1251, or a security manager 1252.

The runtime library 1235 may include, for example, a library module used by a compiler to add a new function through a programming language while the application 1270 is executed. The runtime library 1235 may perform a function about input and output management, memory management, or an arithmetic function.

The application manager 1241 may manage, for example, a life cycle of at least one of the application 1270. The window manager 1242 may manage graphic user interface (GUI) resources used on a screen of the electronic device. The multimedia manager 1243 may ascertain a format necessary for reproducing various media files and may encode or decode a media file using a codec corresponding to the corresponding format. The resource manager 1244 may manage source codes of at least one of the application 1270, and may manage resources of a memory or a storage space, and the like.

The power manager 1245 may act together with, for example, a basic input/output system (BIOS) and the like, may manage a battery or a power source, and may provide power information necessary for an operation of the electronic device. The database manager 1246 may generate, search, or change a database to be used in at least one of the application 1270. The package manager 1247 may manage installation or update of an application distributed by a type of a package file.

The connectivity manager 1248 may manage, for example, wireless connection such as Wi-Fi connection or BT connection, and the like. The notification manager 1249 may display or notify events, such as an arrival message, an appointment, and proximity notification, by a method which is not disturbed to the user. The location manager 1250 may manage location information of the electronic device. The graphic manager 1251 may manage a graphic effect to be provided to the user or a user interface (UI) related to the graphic effect. The security manager 1252 may provide all security functions necessary for system security or user authentication, and the like.

According to an embodiment of the present disclosure, when the electronic device (e.g., an electronic device 100 of FIG. 6A) has a phone function, the middleware 1230 may further include a telephony manager (not shown) for managing a voice or video communication function of the electronic device.

The middleware 1230 may include a middleware module which configures combinations of various functions of the above-described components. The middleware 1230 may provide a module which specializes according to kinds of OSs to provide a differentiated function. Also, the middleware 1230 may dynamically delete some of old components or may add new components.

The API 1260 (e.g., an API 45 of FIG. 6A) may be, for example, a set of API programming functions, and may be provided with different components according to OSs. For example, in case of Android or iOS, one API set may be provided according to platforms. In case of Tizen, two or more API sets may be provided according to platforms.

The application 1270 (e.g., an application program 47 of FIG. 6A) may include one or more of, for example, a home application 1271, a dialer application 1272, a short message service/multimedia message service (SMS/MMS) application 1273, an instant message (IM) application 1274, a browser application 1275, a camera application 1276, an alarm application 1277, a contact application 1278, a voice dial application 1279, an e-mail application 1280, a calendar application 1281, a media player application 1282, an album application 1283, a clock application 1284, a health care application (e.g., an application for measuring quantity of exercise or blood sugar, and the like), or an environment information application (e.g., an application for providing atmospheric pressure information, humidity information, or temperature information, and the like), and the like.

According to an embodiment of the present disclosure, the application 1070 may include an application (hereinafter, for better understanding and ease of description, referred to as “information exchange application”) for exchanging information between the electronic device (e.g., the electronic device 100) and an external electronic device (e.g., the first and second external electronic devices 400 and 500). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device (e.g., the first and second external electronic devices 400 and 500). Also, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of functions of the external electronic device (e.g., the first and second external electronic devices 400 and 500) which communicates with the electronic device, an application which operates in the external electronic device, or a service (e.g., a call service or a message service) provided from the external electronic device.

According to an embodiment of the present disclosure, the application 1270 may include an application (e.g., the health card application of a mobile medical device) which is preset according to attributes of the external electronic device (e.g., the first and second external electronic devices 400 and 500). According to an embodiment of the present disclosure, the application 1270 may include an application received from the external electronic device (e.g., the server device 200 or the first and second external electronic devices 400 and 500). According to an embodiment of the present disclosure, the application 1270 may include a preloaded application or a third party application which may be downloaded from a server. Names of the components of the program module 1210 according to various embodiments of the present disclosure may differ according to kinds of OSs.

According to various embodiments of the present disclosure, at least part of the program module 1210 may be implemented with software, firmware, hardware, or at least two or more combinations thereof. At least part of the program module 1210 may be implemented (e.g., executed) by, for example, a processor (e.g., a processor 120 of FIG. 6A). At least part of the program module 1210 may include, for example, a module, a program, a routine, sets of instructions, or a process, and the like for performing one or more functions.

The terminology “module” used herein may mean, for example, a unit including one of hardware, software, and firmware or two or more combinations thereof. The terminology “module” may be interchangeably used with, for example, terminologies “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

According to various embodiments of the present disclosure, at least part of a device (e.g., modules or the functions) or a method (e.g., operations) may be implemented with, for example, instructions stored in computer-readable storage media which have a program module. When the instructions are executed by a processor (e.g., a processor 120 of FIG. 6A), one or more processors may perform functions corresponding to the instructions. The computer-readable storage media may be, for example, a memory 130 of FIG. 6A.

The computer-readable storage media may include a hard disc, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a ROM, a random access memory (RAM), or a flash memory, and the like), and the like. Also, the program instructions may include not only mechanical codes compiled by a compiler but also high-level language codes which may be executed by a computer using an interpreter and the like. The above-mentioned hardware device may be configured to operate as one or more software modules to perform operations according to various embodiments of the present disclosure, and vice versa.

Modules or program modules according to various embodiments of the present disclosure may include at least one or more of the above-mentioned components, some of the above-mentioned components may be omitted, or other additional components may be further included. Operations executed by modules, program modules, or other components may be executed by a successive method, a parallel method, a repeated method, or a heuristic method. Also, some operations may be executed in a different order or may be omitted, and other operations may be added.

According to various embodiments of the present disclosure, the electronic device may more accurately determine a touch state by collecting information of complex touch types and may prevent error recognition by foreign substance contact.

It is understood that embodiments of the present disclosure described and shown in the drawings are provided as examples to describe technical content and help understanding but do not limit the scope of the present disclosure. Accordingly, it should be interpreted that besides the embodiments listed herein, all modifications or modified forms derived based on the technical ideas of the present disclosure are included in the scope of the present disclosure as defined in the claims, and their equivalents.

What is claimed is:

1. An electronic device, comprising:
an external housing including a transparent plate forming a front surface of the electronic device;
a display panel, at least part of which is exposed through the transparent plate;
a touch panel adjacent the display panel;
a memory; and
a processor operably coupled to the memory,
wherein the memory stores instructions which, when executed by the processor, causes the processor to:
receive first data including an input sensed by a first sensor of a first type through the touch panel, and receive second data including an input sensed by a second sensor of a second type through the touch panel,
compare the first data with the second data to generate a comparison result, and
determine whether an object detected using at least one of the first or second sensors is a foreign object in direct contact with the transparent plate, based on at least part of the comparison result.

2. The electronic device of claim 1, wherein the first sensor is a mutual-capacitance type sensor and the second sensor is a self-capacitance type sensor.

3. The electronic device of claim 2, wherein the mutual-capacitance type sensor is designated for detecting direct touch inputs and the self-capacitance type sensor is designated for detecting hovering inputs.

4. The electronic device of claim 1, wherein the foreign object is a fluidic object.

5. The electronic device of claim 1, wherein the touch panel comprises:
first conductive lines extending in a first direction; and
second conductive lines extending in a second direction orthogonal to the first direction and intersecting the first conductive lines,
wherein the first conductive lines and the second conductive lines each form a part of the first sensor and the second sensor,
wherein the instructions are set such that the processor sequentially or simultaneously provides a first signal to the first conductive lines and senses a change of the first signal in the second conductive lines, in the first sensor, and
wherein the instructions are set such that the processor sequentially or simultaneously provides a second signal to each of the first conductive lines and the second conductive lines and senses a change of the second signal, in the second sensor.

6. The electronic device of claim 1, wherein the instructions are set such that the processor determines that the object is in direct contact with the transparent plate, if an input sensed by the first sensor has a value above a first threshold and if an input sensed by the second sensor has a value above a second threshold,
such that the processor determines that the foreign object is in contact with the transparent plate, if the input sensed by the first sensor has the value above the first threshold and if the input sensed by the second sensor has a value below the second threshold,
such that the processor determines that a touch object hovers above the touch panel, if the input sensed by the first sensor has a value below the first threshold and if the input sensed by the second sensor has a value above the second threshold, or
such that the processor cancels detected nodes, having a sensing value in which the second data have values below the second threshold, among detected points having a sensing value in which the first data have values above the first threshold.

7. The electronic device of claim 1, wherein the instructions are set such that the processor performs sensing using the first sensor a first number of times during a constant period within a period of one frame and performs sensing according to the second sensor a second number of times during a constant period.

8. The electronic device of claim 1, wherein the instructions are set such that the processor alternately performs sensing with the first sensor associated with collecting the first data and sensing with the second sensor associated with collecting the second data during a constant period.

9. The electronic device of claim 1, wherein the instructions are set such that the processor repeatedly calculates a touch node during a period when every frame is displayed according to data collected after alternately performing sensing with the first sensor associated with the first data and sensing with the second sensor associated with collecting the second data.

10. The electronic device of claim 1, wherein the instructions are set such that the processor calculates a touch node according to data collected after performing sensing with the first sensor and sensing with the second sensor, which are performed in a substantially identical manner within a period when one frame is displayed.

11. The electronic device of claim 1, wherein the instructions are set such that the processor activates a pressure sensor and determines a valid touch node, if each of regions of first data with values above a first threshold and second data with values below a second threshold has a predetermined size or more, or such that the processor activates the pressure sensor and determines a valid touch node, if a constant region of first data above the first threshold and a constant region of second data below the second threshold are a predetermined number or more of regions.

12. The electronic device of claim 1, wherein the instructions are set such that the processor activates a pressure sensor and determines a valid touch node, if second data among first data above a first threshold has a value below a second threshold and thereafter has a value above the second threshold at a specific time.

13. The electronic device of claim 1, wherein the memory stores a normal touch sensing value distribution table generated according to the first data and the second data in a state where the foreign object is not in contact with the transparent plate.

14. The electronic device of claim 13, wherein the instructions are set such that the processor determines whether the foreign object is in contact with the transparent plate according to the normal touch sensing value distribution table in a process of initializing a touch module.

15. The electronic device of claim 1, wherein the instructions are set such that the processor determines a corresponding node as a foreign object contact region, if a change of touch capacitance at a node of data having a sensing value of a constant level or more among collected data is within a range during a prescribed time.

16. A method for operating an electronic device, the method comprising:
receiving first data including an input sensed by a first sensor of a first type through a touch panel;
receiving second data including an input sensed by a second sensor of a second type through the touch panel;
comparing the first data with the second data to generate a comparison result; and
determining whether an object detected using at least one of the first or second sensors is a foreign object in direct contact with a front surface of the electronic device, based on at least part of the comparison result.

17. The method of claim 16, wherein the receiving of the first data comprises:
sequentially or simultaneously providing a signal to first conductive lines and sensing a change of the signal in second conductive lines, in the touch panel including the first conducive lines extended in the first direction and the second conductive lines, and
wherein the receiving of the second data comprises:
sequentially or simultaneously providing a signal to each of the first conductive lines and the second conductive lines and sensing a change of the provided signal.

18. The method of claim 17, wherein the determining comprises:
one of determining that the object is in direct contact with the front surface, if an input sensed by the first sensor has a value above a first threshold and if an input sensed by the second sensor has a value above a second threshold,
determining that the foreign object is in contact with the front surface, if the input sensed by the first sensor has a value above the first threshold and if the input sensed by the second sensor is below the second threshold, and
determining that a touch object hovers above the front surface, if the input sensed by the first sensor is below the first threshold and if the input sensed by the second sensor is above the second threshold.

19. The method of claim 16, further comprising:
collecting first data and second data from a touch module within a period of one frame displayed on a display panel,
wherein the determining comprises:
determining a region, where first data of a first reference value or more and second data of a second reference value or more are overlapped and detected, as a valid touch region according to the collected first data and the collected second data.

20. A touch module, comprising:
a touch panel;
a buffer; and
a touch control module configured to electrically connect with the buffer and the touch panel,
wherein the buffer stores instructions set such that the touch control module receives first data including an input sensed by a first sensor of a first type through the touch panel, receives second data including an input sensed by a second sensor of a second type through the touch panel, compares the first data with the second data to generate a comparison result, and determines whether an object is in direct contact with the touch panel, whether the object is proximate the touch panel within a prescribed distance thereof or is not in contact with the touch panel, or whether fluids are in contact with the touch panel, based on at least part of the comparison result.
